(19) United States
(12) Patent Application Publication
(10) Pub. No.: US 2014/0200941 A1
(43) Pub. Date: Jul. 17, 2014

(54) Fulfilling a Contact Center Agent Resource Deficiency

(71) Applicant: NOBLE SYSTEMS CORPORATION, Atlanta, GA (US)

(72) Inventors: Patrick M. McDaniel, Atlanta, GA (US); Karl H. Koster, Sandy Springs, GA (US)

(73) Assignee: NOBLE SYSTEMS CORPORATION, Atlanta, GA (US)

(21) Appl. No.: 13/742,024

(22) Filed: Jan. 15, 2013

(51) Int. Cl. G06Q 10/06

(52) U.S. Cl. CPC G06Q 10/063116
USPC 705/7.16

(57) ABSTRACT

A reserve agent management system allows users, such as contact center agents or administrators, to access and edit reserve schedules for agents. In various embodiments, a reserve schedule indicates times, called reserve times, during a particular agent's off-hours when the agent is willing to receive a recall invitation and potentially return to work. Thus, when a determination is made that additional agent resources are needed, agents having compatible reserve times are notified and invited to be recalled. Agents agreeing to be recalled are then scheduled to work at certain recall times to address the need for additional agent resources. In other embodiments, agents' break times may be shifted to potentially accommodate unexpected changes in required agent resources. Thus, in various embodiments, the reserve agent management system provides administrators and agents with flexibility in adapting agents' schedules to accommodate unplanned needs for agent resources.

### BACKGROUND

Contact centers may receive and/or originate communications, such as telephone calls, for various purposes. The volume of communications, such as inbound telephone calls, may vary based on the time of day, day of week, and time of year. To handle the anticipated volume of communications, forecasts may be produced and a staff of agents is scheduled accordingly. In order to ensure that agents are always available, the agents may be scheduled for various shifts, and typically the starting times may be staggered so that, for example, not all the agents are scheduled to take their lunch break at the same time. This also allows agents to have rest breaks scheduled at different times. To further provide flexibility in allocating agent resources, part-time as well as full-time agents may be employed.

These and other techniques may be available to a contact center in order to match the available agent resources with the anticipated call volumes. However, regardless of how effective these techniques may be employed, it is possible that at various times there will be a deficiency of agent resources. In some instances, there is a level of advanced knowledge that this will occur. For example, it can be expected that for various reasons, one or more agents may occasionally report sick and will be unable to work their scheduled shift, arrive late, or leave early. Or, after agents are scheduled, circumstances may result in a change to the anticipated call volume. In either case, a deficiency of agent resources to handle the call volume may occur.

Similarly, both contact center administrators and agents expect that at various times events or circumstances come up that make adherence to a work schedule difficult or impossible. Further, both administrators and agents desire some flexibility in order to accommodate such events, which sometimes can be anticipated. Thus, it is desirable to have mechanisms that afford agents flexibility in their work schedules, and which offer administrators greater flexibility in allocating agent resources. It is further desirable that such mechanisms are easy to administer and facilitate servicing the anticipated communications.

### BRIEF SUMMARY

In general, various embodiments of the present invention provide computer program products, methods, systems, apparatus, and computing entities for fulfilling a worker resource deficiency by inviting multiple reserve workers to be recalled to work. Reserve workers are generally understood to be workers who have offered to potentially work outside of their scheduled work hours as indicated on reserve schedules. For example, in particular instances, a reserve worker may be a contact center agent, a nurse, a teacher, a sales staff employee, or a wait staff employee who has offered to potentially work outside of their scheduled work hours as indicated on a reserve schedule. Thus, in various embodiments, a reserve schedule for a worker is generally made up of one or more time periods outside scheduled work hours for that worker who has been identified as being potentially available to be recalled to work. Depending on the embodiment, the worker or another individual, such as an administrator, may identify the time periods indicated in the reserve schedule.

Thus, in various embodiments, a worker resource deficiency is identified that comprises a second quantity of worker resources needed to work during a future time period in addition to a first quantity of worker resources currently scheduled to work during the future time period. For instance, in particular embodiments, the worker resource deficiency may comprise a number of additional workers needed to work during a future time period in addition to a number of workers already scheduled to work during the future time period.

Continuing on, a first worker is identified (e.g., a first reserve worker) that who is associated with a first reserve schedule that includes a first time period that coincides with the future time period associated with the worker resource deficiency. In addition, a second worker is identified (e.g., a second reserve worker) who is associated with a second reserve schedule that includes a second time period that coincides with the future time period associated with the worker resource deficiency.

Accordingly, a first invitation is transmitted to the first worker inquiring as to whether the first worker is willing to work during the first time period identified in the first reserve schedule that coincides with the future time period and a second invitation is transmitted to the second worker inquiring as to whether the second worker is willing to work during the second time period identified in the second reserve schedule that coincides with the future time period to fulfill at least a portion of the second quantity of worker resources needed to work during the future time period. In response, replies are typically received from the first and/or second workers indicating whether the workers are willing to work during the first and second time periods, respectfully.

Depending on the embodiment, if the replies indicate the first and second workers are willing to work during the first and second time periods, respectfully, the first and second workers may or may not be recalled, i.e., scheduled to work during the first and second time periods. For instance, in one embodiment, the first worker is recalled to work during the first time period as a result of the first worker having priority over the second worker. However, the second worker may not necessarily be recalled to work during the second time period. For example, in this instance, the second worker may only be recalled and thus scheduled to work during the second time period had the first worker refused to work during the first time period.

In particular embodiments, the first and second invitations are transmitted to the first and second workers, respectfully, in response to the workers meeting an agent qualification. For instance, depending on the embodiment, the agent qualification may be based on the first and/or second worker having seniority, having an acceptable pay rate, having a needed skill level, having a willingness to work during time outside scheduled work hours, having a certain number of hours already scheduled to work, having a certain number of hours already worked over a particular time period, being a member of a team, and/or having a time period already scheduled to work proximate to the future time period. While in other embodiments, the first and second invitations are transmitted to the first and second workers, respectfully, based on a probability of the first and second workers accepting the invitations to work during the first and second time periods.

Further, in particular embodiments, the first and second invitations are transmitted at approximately the same time (e.g., in parallel). While in other embodiments, the second invitation is transmitted some time after the first invitation (e.g., in serial). For instance, in one embodiment, the second invitation is transmitted to the second worker after the first invitation has been transmitted to the first worker and a reply has been received from the first worker. While in another embodiment, the second invitation is transmitted to the second worker only after the first worker has refused to work during the first time period. In particular embodiments, serial transmission of the first and second invitations may occur because the first worker has priority over the second worker.

As is discussed in greater detail below, the subject matter disclosed herein may be implemented as a computer-controlled apparatus, a method, a computing system, or as an article of manufacture such as a computer-readable storage medium. These and various other features will be apparent from the following Detailed Description and the associated drawings.

This Summary is provided to exemplify concepts at a high level form that are further described below in the Detailed Description. This Summary is not intended to identify key or essential features of the claimed subject matter, nor is it intended that this Summary be used to limit the scope of the claimed subject matter. Furthermore, the claimed subject matter is not limited to implementations that address any or all disadvantages noted in any part of this disclosure.

### BRIEF DESCRIPTION OF THE DRAWINGS

Reference will now be made to the accompanying drawings, which are not necessarily drawn to scale, and wherein:

FIG. 1 shows an architecture of a contact center which may employ the various technologies disclosed herein;

FIG. 2 discloses concepts of various types of schedules and time periods associated with an agent;

FIG. 3 discloses a high level overview of a process flow for managing reserve agents according to one embodiment;

FIG. 4 illustrates one embodiment of a graphical user interface illustrating a graphic image indicating various types of time periods of an agent's schedule;

FIG. 5 illustrates one embodiment of a system architecture for facilitating an administrator and/or an agent to access a portal for managing various types of schedules;

FIG. 6 illustrates one embodiment of a triggering process flow;

FIG. 7 illustrates one embodiment of an agent selection process flow;

FIG. 8 illustrates one embodiment of an agent notification process flow;

FIGS. 9A, 9B, and 9C illustrate one embodiment of indicating required agent resources, obtained agent resources, and a remaining agent deficiency;

FIG. 10 illustrates one embodiment of a graphical user interface for informing agents of additional recall opportunities;

FIG. 11 illustrates one embodiment of a process flow for determining incremental pay;

FIG. 12 illustrates one embodiment of a process flow for agent bidding for recall;

FIG. 13 illustrates a second embodiment of a process flow for agent bidding for recall;

FIG. 14 illustrates one embodiment of a graphical user interface for informing agents of a bidding opportunity; and

FIG. 15 illustrates one embodiment of a processing device for practicing the technologies and concepts herein.

### DETAILED DESCRIPTION

Various embodiments for practicing the technologies disclosed herein are described more fully hereinafter with reference to the accompanying drawings, in which some, but not all embodiments of the technologies disclosed are shown. Indeed, the embodiments disclosed herein are provided so that this disclosure will satisfy applicable legal requirements and should not be construed as limiting or precluding other embodiments applying the teachings and concepts disclosed herein. Like numbers in the drawings refer to like elements throughout.

### Exemplary Contact Center Architecture

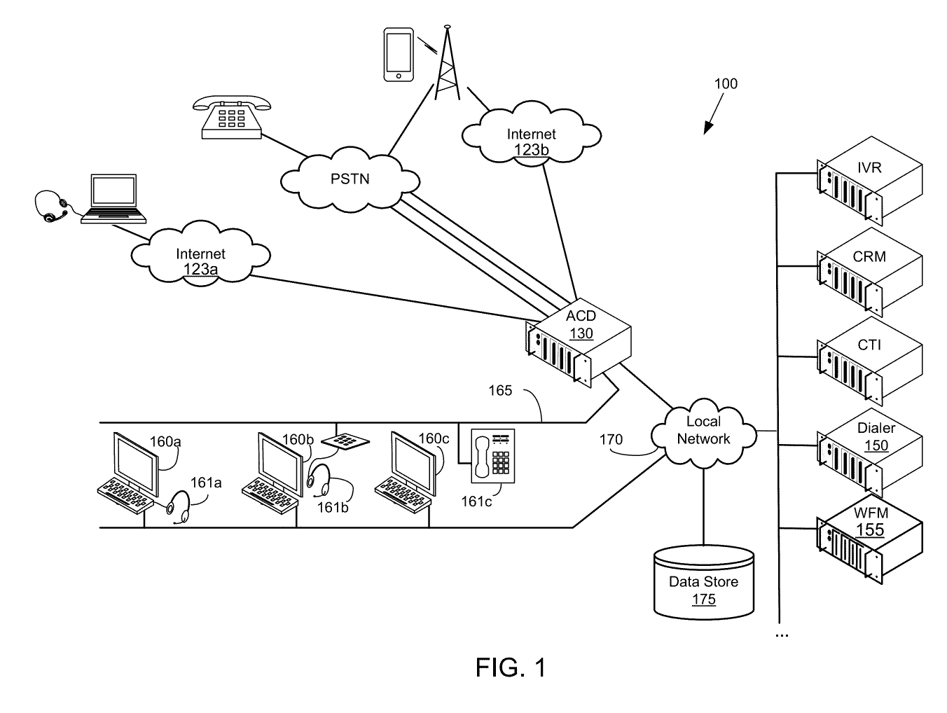

FIG. 1 shows one embodiment of a contact center architecture 100 illustrating the various technologies disclosed herein. The contact center architecture 100 shown in FIG. 1 may involve communications, such as voice calls, that are sent to or originate from the contact center. Although many aspects of contact center operation are disclosed in the context of voice calls, in various embodiments, the contact center may process other forms of communication such as, for example, facsimiles, emails, text messages, video calls, and chat messages. That is, in various embodiments, a call center may be considered a form of a contact center. Thus, for purposes of this disclosure, the term “contact center” is used throughout, although it is understood that the principles may apply to a call center (e.g., a center which only handles telephone calls).

In various embodiments, the contact center employs a dialer 150, such as a predictive dialer, to originate outbound calls on behalf of agents at a rate designed to meet various criteria. Depending on the embodiment, the dialer 150 may comprise one or more software modules executing on a processing device hardware platform. In addition, in various embodiments, the dialer 150 may originate outbound calls by processing a dialing list that includes a collection of records retrieved from a source such as a data store 175. Depending on the embodiment, the data store 175 may be any one of a number of different storage media and may be configured in a number different ways. For example, in particular embodiments, the data store 175 may include one or more databases that store dialing lists as well as other information of importance to the contact center. Furthermore, in certain embodiments, the data store 175 may be integrated with the dialer 150.

A call originated by the dialer 150 may be directed to a targeted party using any number of different devices such as, for example, a computer, telephone, or mobile device. Typically, the dialer 150 connects an outbound call to one of a plurality of contact center agents once a targeted party answers the call. The dialer 150 may directly interface with communication facilities such as public switched telephone network (“PSTN”) trunks (not shown) or with facilities to the Internet (not shown). In some embodiments, the dialer 150 may interface to communication facilities via other components.

In addition, in various embodiments, the contact center makes uses of an automatic call distributor (“ACD”) 130 to receive inbound calls from callers to the contact center. In particular embodiments, the ACD 130 may be a specialized switch for receiving and routing inbound calls under various conditions which can be received from the public switched telephone network (PSTN) or via Internet facilities 123a, 123b. Further, the ACD 130 may be embodied as a dedicated form of equipment readily available from various manufacturers, or the ACD 130 may be a so-called “soft switch” comprising a suitable programming module executed by a processing device to perform the necessary functions. The ACD 130 may route an incoming call over contact center facilities 165 to an available agent. Depending on the embodiment, the facilities 165 may be any suitable technology for conveying the call, including but not limited to a local area network (“LAN”), wide area network (“WAN”), ISDN, or conventional TDM circuits. In addition, the facilities 165 may be the same or different from the facilities used to transport the call to the ACD 130.

The physical area at which an agent sits is often referred to as an agent “position” and these positions are often grouped into clusters managed by a supervisor, who may monitor calls and the agents' productivity. An agent typically uses a computing device 160a-160c, such as a computer, and a voice device 161a-161c. The combination of computing device 160a-160c and voice device 161a-161c may be referred to as a “workstation.” Thus, for these particular embodiments, the workstation collectively has a data capability and a voice capability, although separate devices may be used. In some instances, “workstation” may be used in reference to either the data or voice capability at the agent's position. For example, “routing the call to the agent's workstation” means routing a call to one of the voice devices 161a-161c at the agent's position. Similarly, “routing the call to the agent” means routing a call to the appropriate equipment at an agent's position.

In particular embodiments, the voice device 161a-161c used by an agent may be a soft phone device exemplified by a headset 161a connected to the computer 160a. The soft phone device may be a virtual telephone implemented in part by an application program executing on the computer 160a. Further, the phone may also comprise an Internet Protocol (“IP”) based headset 161b or a conventional phone 161c. Use of the term “phone” is intended to encompass all these types of voice devices used by an agent, unless indicated otherwise.

Agents typically log onto their workstations prior to handling calls. This allows the contact center to know which agents are available for handling calls. In particular embodiments, the ACD 130 may also maintain data of an agent's skill level that may be used to route a specific call to the agent or group of agents having the same skill level. In particular instances, if a suitable agent is not available to handle a call, the ACD 130 may queue the call for the next available agent. As can be expected, various algorithms may be employed to process calls in an efficient manner.

Depending on the embodiment, interaction between the ACD 130, the dialer 150, the agent computers 160a-160c, as well as other components, may involve using a local area network (“LAN”) 170. However, other configurations are possible, such as, but not limited to, using a wide area network, wireless network, router, bridge, direct point-to-point links, etc.

The contact center may also employ a workforce management system (“WFM”) 155 which can be used to create work schedules for the agents. The WFM 155 can be a repository for generating and storing work schedules, campaign information, and other workforce administration information. In some embodiments, the functions of the WFM 155 and other components described herein may be integrated.

The above components may be referred to as a “computing device,” “processing device,” or “system.” This may incorporate the local data store 175 and/or interface with an external data store. Further, the above components may be located remotely from (or co-located with) other components. Furthermore, one or more of the components may be implemented on a single processing device to perform the functions described herein. For example, in various embodiments, the functionality of the dialer 150 may also be incorporated with other contact center components.

In addition, the contact center architecture 100 may be provided as a hosted solution, where the call processing functionality is provided as a communication service (a so-called “communication-as-a-service” or “CaaS”) to a contact center operator. Thus, there is no requirement that the components identified above actually be located or controlled by a contact center operator.

In addition, depending on the embodiment, the agent positions may be co-located in a single physical contact center or multiple physical contact centers. The agents may be remotely located from the other components of the contact center, and may also be remotely located from each other, sometimes referred to as a “virtual contact center.” In particular instances, a virtual contact center may describe a scenario in which agents work at home, using their own computers and telephones as workstations. In some configurations, a single physical location of the contact center may not be readily identifiable. For instance, this may occur when the call processing functions are provided as a service in a hosted cloud computing environment and the agents positions are in their individual residences.

### Reserve Agent Service Concepts

The concepts and technologies disclosed herein generally involve a reserve agent management system (“RAMS”) that can be used by a contact center to request or assign additional agent resources as needed. In some embodiments, the contact center may ascertain a need for such additional agent resources and may request and/or reassign agent resources to address the additional agent resources needed. The determination that additional agent resources are needed, or need to be reassigned, at certain times can originate from a variety of sources, including the agents themselves. If an insufficient number of agents are scheduled to handle an anticipated communication volume, then an agent resource deficiency may occur, which is generally preferable to avoid.

Although the concepts and technologies disclosed herein are illustrated using a contact center, application is possible to other circumstances. In general, whenever a number of human resources are scheduled to accomplish a defined task, the concepts and technologies disclosed herein can be adapted to provide similar benefits as those provided to a contact center. By way of example, and not limitation, this could include other professionals such as nurses, teachers, and sales staff. Furthermore, the concepts and technologies disclosed herein could also apply to non-skilled workers.

In some instances, the agent resource deficiency can be overcome by rearranging the work schedules of the existing agents. This includes, for example, shifting the break times of the agents to result in more agents working when the increase in demand is present. In other instances, this is not sufficient to meet the anticipated demand and agents may be asked to work during their “off-hours.” The process of having an agent work during a non-scheduled time is referred to as “recalling” the agent and a “recalled” agent is one who has agreed to work or is currently working during a previously scheduled off-hour that was designated as “reserve time.” Once the reserve time is actually being worked, it is referred to as “recall time.”

Thus, in particular embodiments, the time periods outside the normally scheduled work hours for an agent that may be available to the contact center operator to recall the agent is referred to as “reserve hours” or “reserve time.” Reserve time offers a buffer to the contact center operator and indicates when additional time, if required, can be obtained. Accordingly, a “reserve agent” is an agent that has offered to potentially work outside of their regularly scheduled work times. Given this definition, an agent's “reserve schedule” indicates reserve times, which are the times indicated by an agent as being potentially available for recall. That is, in various embodiments, a “reserve schedule” is logically distinct from an agent's conventional work schedule (also referred herein as a “primary schedule”). Thus, the reserve schedule does not necessarily reflect times when the agent has or will work, but indicates times when potentially the agent may work. In some embodiments, the reserve schedule may reflect reserve times that the agent may agree to work and is not necessarily required to work, if requested. While in other embodiments, the reserve schedule may reflect reserve times that the agent is required to work, if requested.

An agent may often agree to be recalled if the circumstances are convenient or if the circumstances are otherwise desirable for the agent. For example, if an agent works in a physical contact center location and must commute from home to work, an agent may be more willing to be recalled if the recall time is contiguous with their work schedule (e.g., just before or just after their scheduled shift). However, if the agent works remotely, e.g., from home, then the agent may be willing to be recalled to work an hour or two on their day off. Another consideration is the contact center operator may allocate additional pay as an incentive for an agent to be recalled. In these particular instances, the rate may depend on when the recall occurs and how long it is. For example, a recall just before or after an agent's shift may have a 1× multiplier for pay adjustment. However, if the recall time occurs on a Saturday when the agent normally has a day off, the recall time period may have a 2× multiplier.

Conventionally, an agent is associated with a work schedule (i.e., the primary schedule) that defines the agent's shifts when they are scheduled to work. That is, the shifts on an agent's work schedule indicate times when the agent is expected to be working, e.g., handling calls, as well as times the agent is expected to be on a break. Breaks are typically considered times when the agent is not handling calls while working a shift. This may include various types of breaks such as, for instance, rest breaks, lunch breaks, and training breaks. For example, an agent scheduled for an eight-hour shift may have a mid-morning fifteen minute rest break, a mid-day forty minute lunch break, and another mid-afternoon fifteen minute rest break. On certain days, a period of time may be allocated for training as needed. Thus, a rest break and lunch break may be times that are differentiated from a training break. Namely, in some instances, an agent is considered to be “on-the-clock,” so to speak, during a training break. Thus, a training break may also be referred to as a “training session” to distinguish it from the other breaks.

While an agent's work schedule defines the times when the agent is expected to be working (e.g., is expected to be handling calls or involved in a training session), the work schedule also implicitly defines when the agent is unavailable, e.g., the agent's “off-hours.” “Off-hours” mean the times between an agent's shifts. For example, an agent may work a day-shift from 9:00 a.m. to 5:00 p.m. and while although the shift may involve various breaks when the agent is not actively handling calls, the agent is considered to be “off-hours” after 5:00 p.m. to 9:00 a.m. the next day. The agent could also be described as being “off-duty.”

In various embodiments, a reserve agent may also be considered an agent who may be available to work (e.g., handle inbound or outbound contacts) during a scheduled break during their shift in addition to an agent who may be recalled during certain times in their off-hours. These are two separate approaches for obtaining additional agent resources and, depending on the embodiment, these two approaches may involve slightly different procedures. For convenience, having an agent work during a schedule break or during off-hours may be referred to as “recalling an agent.”

Thus, the first approach involves an agent working through a scheduled break, such as a rest break or lunch break. In addition, the agent could also work through a training session, which can be viewed as effectively cancelling the training session for the agent. In other words, if the agent is not in training, then they would otherwise be handling calls and cancelling the training session results in the agent being available to handle calls.

Although the agent could work through a break, for a variety of reasons it may be necessary for the contact center administrator to shift the time of the break as opposed to cancelling the break. For instance, in some embodiments, regulations or contractual obligations may require a rest break for agents at certain periods and/or a lunch break at certain time windows. Thus, this approach is referred to as “shifting a break” or “break-shifting”, since the agent may be taking the break at another time.

The second approach involves recalling the agent so that the agent works during their off-hours. This could involve, for example, an agent starting an hour earlier from their scheduled shift, working an hour later after their shift (e.g., off-hours), or working on a day off.

To summarize, a reserve agent is an agent who may work during their off-hours, on a day off, during a break, or during an otherwise scheduled training session. A recalled agent is an agent who is to work or who is working during their off-hours, on a day off, during a break, or during a scheduled training session. In each of these cases, the agent was not originally scheduled to be available for handling calls or other forms of communication, but is now available. It is evident that each reserve agent is an agent, e.g., they have a schedule for working. However, each agent is not necessarily a recallable agent. That is, an agent may be unavailable to be recalled to work off-hours and hence is not considered a reserve agent. Further, each recalled agent is also a reserve agent. That is, a recalled agent is a reserve agent that is, or who has committed to, working during a particular reserve time.

As mentioned, an agent may also become a recalled agent in that the agent may have a scheduled training session cancelled and they may be assigned to handle calls instead. It becomes evident that particular instances of an agent working through a training session are a special case that may have slightly different procedures associated with this type of situation. Typically, a contact center schedules an agent for handling calls and occasionally schedules the agent for training sessions. The contact center operator typically determines when, and if, agent training is required and has the prerogative of unilaterally canceling training for the agent. Thus, with the training cancelled, the agent reverts to handling calls as normal. In this instance, the agent can be viewed as a special form of recalled agent during this time.

Typically, the reserve schedule refers to times that the agent is normally not handling calls, but has consented to possibly handle calls, i.e., when the agent has consented to possibly being recalled. The reserve schedule largely involves the agent's off-duty time however it is possible the schedule may also involve on-duty time. Namely, the agent may agree to possibly work during a break and this may be displayed on the reserve schedule as reserve time. This distinction should be kept in mind in considering the following concepts and technologies. In addition, to better distinguish between the reserve schedule and a conventional work schedule, the conventional work schedule is henceforth referred to as the “primary schedule.” The combination of the reserve schedule and the primary schedule is referred to as the “master schedule.” Further, in some circumstances which should be evident based on the context, the reserve schedule may be in reference to either a particular agent, or to a group of agents.

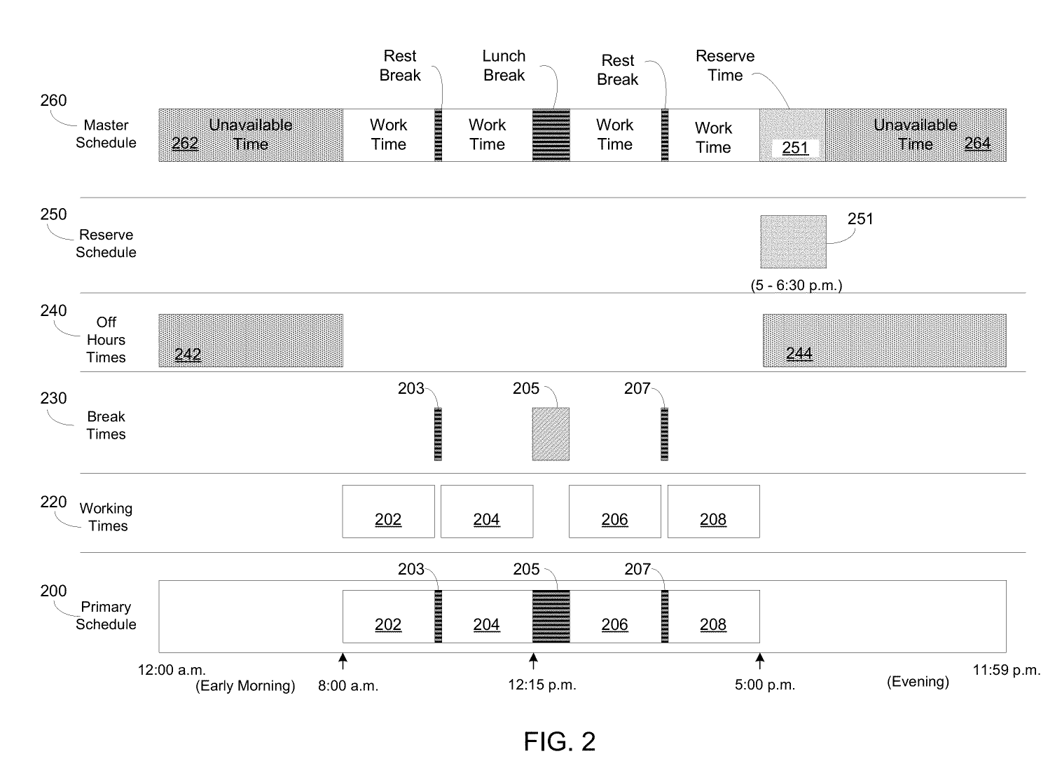

The concepts of these various types of schedules and time periods associated therein are illustrated in FIG. 2. Depending on the embodiment, the logical operations described herein may be implemented (1) as a sequence of computer implemented acts or one or more program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof. Greater or fewer operations may be performed than shown in the figures and described herein. These operations may also be performed in a different order than those described herein.

Turning now to FIG. 2, the schedules and associated time periods are shown as “stacked” schedules where the horizontal axis represents time comprising various time periods. The schedules shown depict a single day, but this could also be expanded to depict a weekly period or other time periods. Other formats could be used to represent the time periods. The depiction is logical and intended to convey the various concepts and does not limit how the data is actually stored in an embodiment or presented to a user. The figures are not necessarily drawn to scale.

A primary schedule 200 is logically depicted for a hypothetical agent. This schedule 200 represents a single 24-hour day via a horizontal rectangle beginning at 12:00 a.m. on the left side and continuing to 11:59 p.m. on the right side. In the primary schedule 200, the agent starts their shift at 8:00 a.m. by beginning their first period of work time 202. Work time 202 in this figure refers to the time when the agent is handling calls. Around mid-morning, a rest break 203 occurs, followed by a second work time 204. Then at 12:15 p.m. a lunch break 205 occurs, followed by a similar schedule comprising afternoon work times 206, 208 with a second rest break 207 in between. The agent's shift ends at 5:00 p.m.

The primary schedule 200 can be deconstructed into a working times schedule 220 that includes only the working times 202, 204, 206, 208. During these times, the contact center can presume that the agent is available for handling communications. The break times schedule 230 includes a similar deconstructed view of only the breaks 203, 205, 207. Various contractual and regulatory constraints may govern when these breaks 203, 205, 207 may occur and how long they are. For example, it may be possible to shift forward a rest break by fifteen minutes, but typically it cannot be moved from the morning to the afternoon. Further, it may be possible to shift a lunch break a certain amount of time, but it may not be allowed to be moved to the end of the last working time 208.

The off-hours times schedule 240 shows the time periods of off-hours times 242, 244, which are the times in the primary schedule 200 that the agent is not working and is not engaged in a break. In this example, the off-hours times 242, 244 include 12:00 a.m. to 8:00 a.m. and 5:00 p.m. to 11:59 p.m. for the day. The off-hours are implicitly defined based on the primary schedule. Thus, while the off-hours are not scheduled in the normal sense, scheduling the working and break times defines when the off-hours occur.

The next schedule shown is the reserve schedule 250. This schedule 250 shows the reserve time period 251, which is the time during the off-hours times 242, 244 that the agent has agreed to be potentially available, if requested, to work. In this embodiment, there is one reserve time period 251 indicated as 5:00 p.m.-6:30 p.m., which is after the shift of the agent. Presumably, if the contact center has a number of agents (with different shift times), then collectively there are a number of reserve time periods covering various times when the contact center could request a reserve agent to become a recalled agent. For example, agents assigned to an evening shift (e.g., 4:00 p.m. to 12:00 a.m.) may agree to be recalled during a reserve time before their shift, such as between 1:00 p.m.-4:00 p.m. This would allow the contact center to augment their staffing early afternoon by requesting agents in this reserve time period to work.

Returning briefly to the break times schedule 230, it is possible that some additional reserve capacity can be obtained to meet a defined need by shifting one of the breaks 203, 205, 207 for a plurality of agents. However, there are typically limitations as to how much these breaks 203, 205, 207 may be shifted. Further, some of the breaks 203, 207 are relatively short (e.g., 15 minutes). Furthermore, shifting a break 203, 205, 207 may add agent resources during one time period but may result in a deficiency of agent resources in another time period during the same shift. Thus, obtaining additional agent resource capacity may be possible by break-shifting. However, break-shifting may be insufficient to meet the need and instead may merely shift the agent resource deficiency to another time period.

The master schedule 260 reflects how all of the various time segments are associated for a single agent. In particular embodiments, the data for a master schedule 260 for an agent may be stored in a data structure in a WFM 155. In some embodiments, existing primary schedule data structures generated and maintained by the WFM 155 may be augmented to incorporate the concepts identified above, as opposed to maintaining another data structure. However, regardless of how the various schedule data is stored, the reserve schedule 250 can be conceptually viewed as separate from the primary schedule 200.

In particular embodiments, the master schedule 260 can reclassify the off-hours designation, as indicated in the off-hours times schedule 240, into two separate designations: unavailable times 262, 264 and reserve times 251. If the agent designates a portion of their off-time as potentially being available for recall, then that time is designated as reserve time 251. The remaining times are classified as “unavailable.” In essence, unavailable times 262, 264 are times that are not eligible for recalling that agent. These times 262, 264 can be described as off-hours times that really are off-limits for working. The unavailable times 262, 264 could reflect, for example, prior commitments of the agent such that they would refuse any recall request during these times. For instance, it could reflect a time at which they must pick up a child from daycare, attend an event, etc.

In some embodiments, an agent may be liberal in designating their off-hours times as reserve times. That is, the agent may take the view that they would like to be offered the opportunity to be recalled at any time, knowing that they can always deny the invitation to be recalled if it is inconvenient to the agent. However, from the contact center administrator's perspective, it may be undesirable to have reserve times in an agent's reserve schedule that are unlikely to be accepted as recall times by the agent. That is, it may be undesirable to have reserve times indicated in a reserve schedule that are not a reliable indicator of when the agent may be recalled. Therefore, the administrator would prefer that any indicated reserve time in a reserve schedule can be relied upon as potential recall time. To this extent, mechanisms can be defined that eventually “weed out” or discourage such agents from indicating reserve times and then refusing to accept recall invitations. For example, one mechanism could calculate a probability of an agent accepting an invitation based on the agent's acceptance and rejection of past invitations, and if the agent's probability drops below a certain threshold, then the agent may be precluded from indicating any further reserve time or may have any existing reserve times deleted. Additional tools can also serve to remove such agent's reserve schedule from their master schedule. Other tools may assign a lower priority in extending a recall invitation to that agent if other agents are identified that could also fulfill the agent deficiency.

### General Process Flow

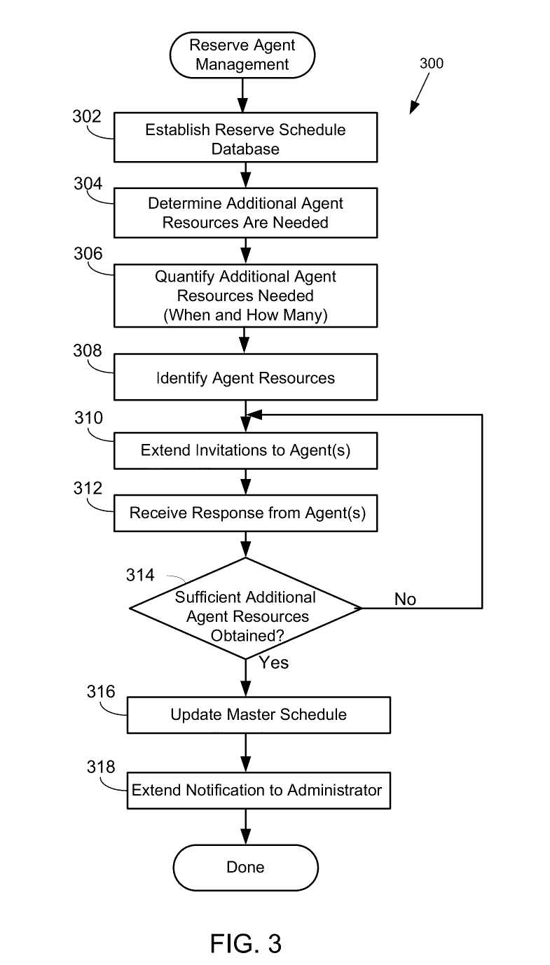

One embodiment for managing reserve agents in the RAMS is shown in FIG. 3. The process provides a high level overview of some of the operations that may be present that are discussed in further detail below. As will be evident, variations on and within this process flow are possible, and FIG. 3 illustrates only one embodiment.

The process 300 begins with establishing a database of reserve schedules in operation 302. Typically, this database is established before there is even a need detected due to an agent deficiency. That is, in various embodiments, the establishment of reserve schedules for agents may be completed well in advance of the subsequent steps of the process 300 such as, for instance, well in advance of when a determination is made that additional agent resources are required. This could be done days, weeks, or even longer in advance.

The opportunity to establish a reserve schedule is typically offered to all the agents in the contact center. In one embodiment, this can be done using surveys, asking agents to interact with a web site for viewing and defining their reserve schedules, or via email to an administrator who enters the information. This operation 302 essentially involves agents identifying any times during their off-hours (and potentially breaks) when they would be willing to be possibly recalled for work. Various mechanisms, which will be discussed further, can be used to generate and/or maintain an agent's reserve schedule such as, for example, a portal accessed by a mobile device from which the agent can access their various schedules.

For example, in one embodiment, the agents may use the portal to view their primary schedules and generate define their reserve schedules. This may involve the agents selecting which time periods on which days they would be willing to be recalled. Just by way of example and not limitation, an agent may be willing to identify hours just prior to, or just after, their conventional work shifts as reserve times. Or, an agent may be willing to identify times on their days off as reserve times. If the agent pool is large enough, it is likely that when additional agent resources are needed there will be sufficient reserve times to cover the need. An agent could initially create a reserve schedule and update it on an “as-needed” basis, or periodically, such as once every month. In some embodiments, the contact center may publish historical time periods when agents were recalled so that agents may define reserve times coincident with these historical time periods to increase the agents' likelihood of receiving a recall invitation.

In particular embodiments, agents could be required to specify a minimum time duration for a reserve time period, e.g., on a thirty or sixty minutes basis. It is often desirable for the minimum reserve time period to be a whole number multiple of the minimum time period used by the WFM. For example, the WFM may manage resources in fifteen minute intervals, but it may be difficult to have an agent agree to be recalled for fifteen minutes. Rather, an agent may expect to be recalled for a minimum of, e.g., an hour. Further, the contact center may conduct forecasting using an hourly basis, and thus, resources are required to work for at least an hour.

The next operation 304 in the process 300 involves determining that additional agent resources are needed. Generally, the determination of “additional agent resources” is relative to the agent resources currently scheduled or working. In other words, if agent resources have been scheduled, a determination is made that additional agent resources are required at some point after these agent resources have been scheduled. Depending on the circumstances, this determination may be made in advance of the shift being worked or during the shift as it is being worked. For instance, it is possible, for example, that sufficient agent resources have been scheduled but inclement weather has result in a number of agents being unable to arrive at the contact center and an agent deficiency is determined.

For example, in one embodiment, a contact center may generate an agent workforce schedule every two weeks. This allows agents to know in advance which days and times they are working and which they are not over the two weeks. Further, the schedule may be relatively static. That is, some agents may generally have the day shift and start at either 9:00 a.m. or 9:30 a.m., while other agents may generally have the evening shift and start at other certain times. Therefore, in this example, a determination may be made that additional agents are required either during the time a campaign is being conducted over a particular two-week period or before the campaign has started, but after the schedule for the two-week period has been set. Thus, an agent deficiency is typically not determined until agents have been scheduled.

Depending on the embodiment, this determination may be made in a number of different ways. For instance, during a campaign or a given shift, existing service levels may be monitored (such as call waiting times) throughout the working hours and determined to be unacceptable. Or, certain business goals may be monitored during a campaign and determined to be unmet. Other mechanisms may be involved in the determination as will be discussed further. For instance, in particular embodiments, a threshold value may be defined for a monitored parameter in which a measurement of the parameter, when compared to the threshold value, causes a determination to be made that additional resources are required. In addition, the determination may be made in advance of a campaign. For instance, in particular embodiments, forecasting tools may indicate that an agent resource deficiency is expected.

Furthermore, in particular embodiments, the process for determining whether an additional agent resource is needed may involve ascertaining that there is a sustained agent resource deficiency. In these particular embodiments, mechanisms may be defined to avoid “false reports” in which a minor measurement aberration triggers recalling agents in instances when the aberration is not indicative of a sustained need. For instance, it may take the contact center a minimum time period to recall an agent and, thus, the contact center may wish to avoid a temporary resource deficiency from triggering an agent recall if the deficiency only lasts a short time.

In the next operation 306, a determination is made of the quantity and times of when the additional agent resources are required. In essence, this operation 306 involves determining how many agents are required and at what times. Depending on the embodiment, this may be measured in various ways. For instance, in one embodiment, a specific duration may be assumed such as for a thirty minute or one hour time period. For example, the quantity and time could be defined as: an additional five agents are required for one hour starting at 2:00 p.m. (e.g., all five agents are required at one time between 2:00-3:00 p.m.) Or, the requirement may be stated as five agent-hours starting at 1:00 p.m. and continuing through 6:00 p.m. (e.g., one additional agent is required for five consecutive hours). A combination of different levels of agent resources may be required for different contiguous time periods. Other combinations may exist.

In particular embodiments, the combination of the determination that additional resources are required and the determination of how many and when these resources are required (operations 304 and 306) are collectively referred to as “triggering.” The triggering operations may monitor or otherwise involve other systems which detect, analyze, and quantify an agent resource deficiency. As can be expected, a number of different ways can be defined as to how an agent deficiency is detected and quantified.

After the number of agent resources required has been quantified, the next operation 308 is to identify or select the agent resources that potentially can fill the defined deficiency. This involves determining which agents have reserve times and when these reserve times are available so that these reserve times may be analyzed to see if they can potentially be used to meet the defined deficiency. For example, assume five agents are needed for one hour starting at 2:00 p.m. It would not be beneficial to select an agent having a reserve hour starting at 5:00 p.m. because this would be too late to address the need starting at 2:00 p.m. However, it may be beneficial to identify an agent who has a day off and has indicated they may be willing to work in the afternoon (e.g., they have indicated the afternoon as reserve time). Similarly, it may be beneficial to identify an agent working a shift ending at 2:00 p.m. and that has indicated reserve time is available beginning at 2:00 p.m.

In various embodiments, there may be instances in which a number of agents could potentially be selected for meeting the resource deficiency. Thus, in particular embodiments, when there are more agents available than required to meet the deficiency, then rules may be defined indicating how the agents are selected. As will be discussed further, a myriad of rules can be defined indicating how agents are selected and this may impact how the agents are informed.

Further, in particular embodiments, agent selection may be defined by a priority metric that indicates a weighting for defining which agents are selected first. Depending on the embodiment, the metric may be based on, for example, seniority, pay rate for the agent, skill level, willingness to work reserve time, etc. That is, for example, this metric may favor eligible agents first respectively based on: seniority, inversely proportional to their hourly pay rate, those having skill levels matching needed skills for the deficiency, those who previously accepted requests for reserve time, etc.

Once the agents are identified, then a notification is extended to these agents in operation 310. Depending on the embodiment, the notification may be in any one of several forms. For instance, a common form can be described as an invitation or recall request to the agent asking the agent if they would agree to be recalled. In various embodiments, if the reserve agent is giving up time during their off-hours, then it may be appropriate to confirm with the agent whether they can accommodate the request. On the other hand, if the reserve agent is required to have their lunch break shifted by fifteen minutes, then the reserve agent may simply be told (as opposed to being asked) that this is occurring. Similarly, if a training session is cancelled by the administrator, then the agent may simply be told that the training is cancelled or postponed and that the agent is now required to handle calls during this time.

Further, in particular embodiments, the contact center operator may have negotiated up-front with agents that certain reserve times are mandatory and/or discretionary. For example, while the majority of reserve times for agents' off-hours are discretionary for recall, the contact center operator may have negotiated that the first hour of reserve time after an agent's shift is considered mandatory for recall purposes. That is, in this example, although the second hour after an agent's shift and those thereafter may be optional or discretionary for recall, the first hour after an agent's shift is available for mandatory recall.

In addition, in particular embodiments, a recall invitation may be sent to a mobile device associated with an agent. For instance, the invitation may be sent as a text message to the agent's mobile device or via email to the agent's indicated email address that is accessible on the agent's mobile device. A phone call may also be instituted. The form of the communication may depend on various factors, including the urgency, agent preferences, etc. In other embodiments, the invitation may also be sent to the agent's desktop if the agent is currently logged in. Other forms of communication are possible.

Depending on the circumstances, the discretionary recall invitations in operation 310 can be sent serially or in parallel to a group of eligible reserve agents. For instance, in one embodiment, the invitations are sent in parallel (e.g., “blasted”) and their responses are received in operation 312 as the agents respond. While in another embodiment, the invitations are sent serially and a response or timeout may govern when the next invitation is sent out to the next agent. For this particular approach, once the required agent resources are obtained, typically no further invitations are extended. Further, the latter approach (serial invitations) may take more time than the former approach (parallel invitations) and thus circumstances may not always allow for serial invitations to be sent. Variations are possible, such as sending a “mini-blast” of a subset of the invitations to a subset of the group of agents, waiting for their response (or a timeout), and then sending another mini-blast of another subset to a second group, and so forth.

As the responses are received from agents that confirm or reject the recall invitation, the responses are analyzed to determine whether sufficient agent resources have been recalled in operation 314 such that no further recall invitations need to be sent out. If an insufficient level of agent resources has been recalled, then the process 300 loops back to operation 310. In a particular embodiment, an insufficient level of agent resources may be determined based on an expected number of reserve hours to be obtained based on each agent's likelihood of accepting the invitation for a given time. For example, if ten agent hours are required to offset a deficiency and a set of twenty agents are identified in which each agent may contribute a single reserve hour and each agent has a 50% historical acceptance rate, then the expected reserve hours would be: twenty agents at one reserve hour*0.5 probability of accepting=ten expected reserve hours. Thus, there are a sufficient expected number of reserve hours to meet the deficiency. Once agents have accepted, the recalled agents have their master schedules updated in operation 316 to reflect the appropriate recall times for the agents. Depending on the embodiment, the master schedule may be maintained by the WFM 155.

In operation 318, an indication is provided to the administrator that reflects a summary of the results. For instance, the indication may inform the administrator whether the deficiency was meet, which agents accepted the recall invitation, any unmet resource deficiency remaining, etc. At this point, the process 300 is completed. Subsequently, when the respective recall time arrives for each recalled agent, the WFM 155 knows that the recalled agent is expected to be available and allows the recalled agent to log into the contact center (or remain logged in, if merely extending their shift hours) to handle calls.

### Architecture for Managing the Reserve Schedule

Various tools and architectures can be defined for managing a reserve schedule. Typically, a reserve schedule is generated based on agent review and input after a primary schedule is developed for the agent. In one embodiment, the agent reviews the primary schedule and then generates and/or edits their reserve schedule. Thus, in various embodiments, it may be necessary to first have a primary schedule developed, which typically is done by the WFM, and then the tools and architecture allow the agent to review the primary schedule created by the WFM and provide input to generate and/or update a reserve schedule, which may also be maintained by the WFM 155.

Typically, the WFM 155 creates the primary schedule under the direction of the contact center administrator who is given authorization to view and edit any of the primary schedules. However, in various embodiments, the roles of the agents and the administrator are different with respect to each other and the reserve schedules. Specifically, with regard to primary schedules, the administrator has authorization to control the work times while agents may be limited to only reviewing their respective primary schedule. Thus, typically, an agent is not allowed to directly edit or alter their work times identified on the primary schedule after the schedule has been generated.

However, with regard to reserve schedules, agents typically are allowed to edit the times indicated as reserve times on these schedules. In some embodiments (although not all), the administrator may be limited to only reviewing the reserve times and is unable to change them. Thus, with respect to controlling schedules, in various embodiments, the administrator controls the primary schedules and the agents control the reserve schedules.

Note, however, that is some embodiments, the administrator may be able to control the reserve times of an agent. For instance, in particular embodiments, the administrator may add reserve hours for an agent after receiving authorization from the agent. For example, an agent without Internet access may verbally indicate to the administrator that they would like to change the status of their reserve times and may request the administrator to make the change on their behalf. While in another embodiment, the administrator may be able to remove reserve hours for an agent. For example, the administrator may remove reserve hours for an underperforming agent, for an agent that is at the maximum allowed reserve hours, or for an agent that consistently refuses to accept recall invitations. In other embodiments, in which agents may be required to define a minimum number of reserve times, the administrator may create the reserve time on behalf of the agent.

Thus, in various embodiments, the primary schedule is used by the WFM and the contact center for indicating when an agent should be working and, therefore, various controls are necessary before an agent's primary schedule can be changed. However, because the reserve schedule functions slightly different, it may be possible in these embodiments to allow greater flexibility in the controls with respect to allowing an agent to alter their reserve times. Generally, once the agent is authenticated, the system may allow that agent to alter their reserve schedule at any time.

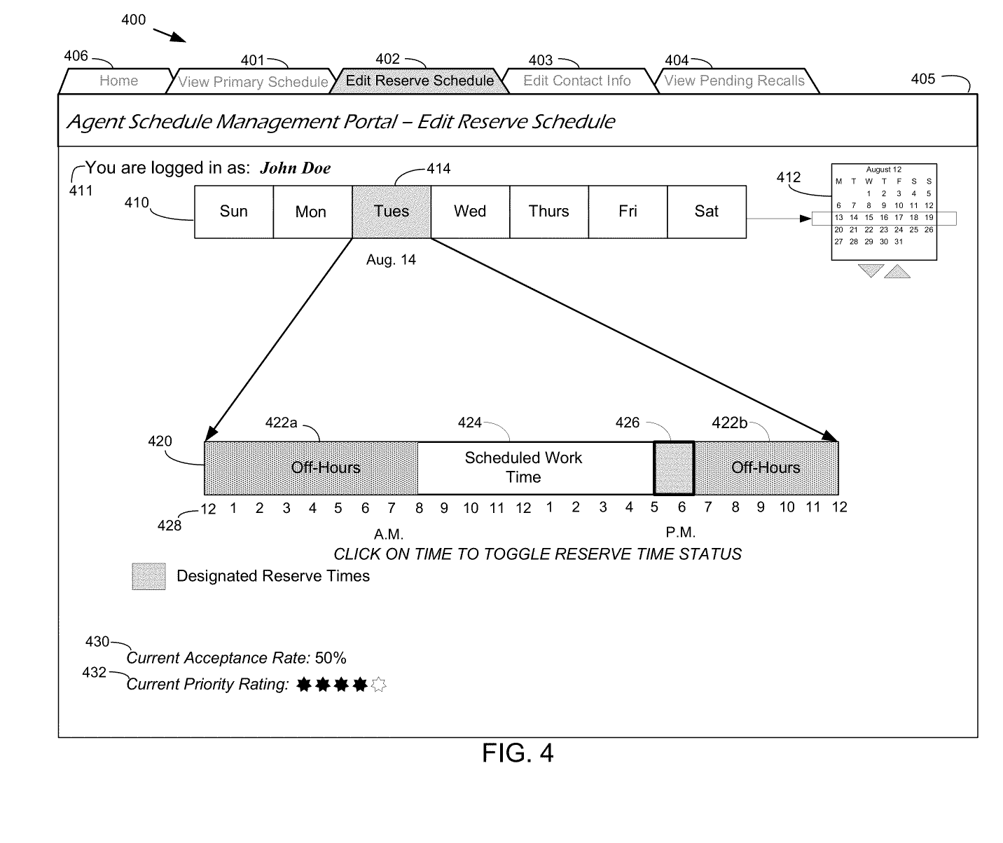

FIG. 4 provides an embodiment of a graphical user interface (“GUI”) 400 illustrating a graphic image indicating various types of time periods of an agent's schedule. In this embodiment, the GUI 400 provides a number of different tabs 401, 402, 403, 404, 406 along the top that allow the agent to view various screens provided by the GUI 400. For instance, the agent may select the “View Primary Schedule” tab 401 to be taken to a screen that displays the agent's primary schedule. In this instance, the agent has selected the “Edit Reserve Schedule” tab 402 to display a screen 405 on which the agent may view and/or edit their reserve times. Once on the screen 405, the screen 405 indicates that the agent “John Doe” 411 is logged into the RAMS. At this point, the agent selects a specific week the agent is interested in viewing from the calendar 412 on the right side of the screen 405. In particular instances, this may default to the current week.

In response, the screen 405 displays icons 410 for the days-of-the-week for the selected week and may present the current day by default, which the agent may alter. Assuming the selected day is Tuesday, August 14^{th} 414, this view 420 for the agent is provided in expanded form. As a result, the screen 405 provides an expanded view 420 of this day 414 providing additional details on the agent's types of time for the particular day 414. In this instance, the details include the hours 428 for the day along the bottom edge of the view 420 staring with 12:00 a.m. for the selected day and ending with 12:00 a.m. for the following day. Further, the view 420 shows the agent has off-hours 422a from 12:00 a.m. until 8:00 a.m. on the selected day. Further, the agent is scheduled to work (i.e., the agent has scheduled work time 424) starting at 8:00 a.m. until 5:00 p.m. In addition, the agent again has off-hours from 5:00 p.m. until 12:00 a.m. (midnight) following the agent's work shift. However, in this instance the agent has designated part of this time from 5:00 p.m. until 6:30 p.m. as reserve time 426 and the balance of this time 422b remains off-hours (e.g., unavailable hours).

At this point, the agent may edit the identified reserve time 426 or may provide additional reserve time during one of the off-hours time periods 422a, 422b. Note, however, in this instance the agent is not provided with capabilities to edit the scheduled work time 424. For example, the agent may decide that they would like to designate the reserve time after their shift as two hours instead of one hour and a half. Therefore, the agent highlights the extended view 420 from 5:00 p.m. to 7:00 p.m. using their mouse device. In response, the GUI 400 generates a popup screen (not shown) that provides a listing of different types of time the agent may designated for this highlighted time period. In this instance, the agent is provided with the options to designate the highlighted time period as either off-hours or reserve time. In other embodiments, the agent may indicate the time period via text input or other means. Accordingly, the agent selects reserve time, validates the selection, and the screen 405 updates to now display the reserve time 426 as being from 5:00 p.m. to 7:00 p.m. In other instances, other user interface forms may be used to effect the changes.

Finally, it is noted that the particular embodiment of the “Edit Reserve Schedule” screen 405 provided in FIG. 4 also displays the agent's current acceptance rate 430 and current priority rating 432 with respect to being invited to work during the agent's designated reserve time 426. Such information helps to inform the agent of the agent's acceptance rate upon receiving an invitation to be recalled to work. Further, the agent's current priority rating 432 and/or their acceptance rate 430 can be used to determine whether to invite the agent to be recalled in future circumstances.

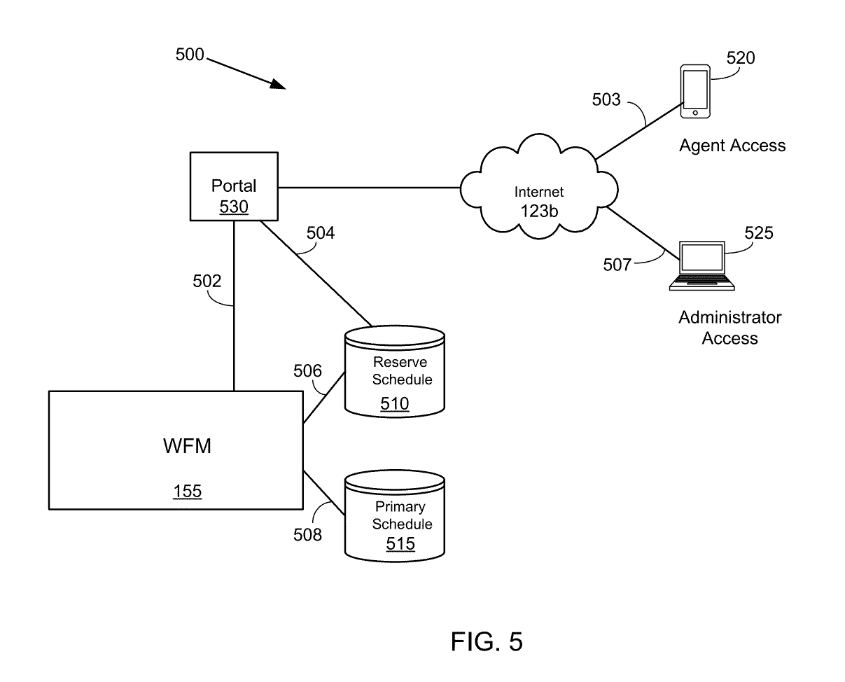

Turning now to FIG. 5, an embodiment of a system architecture 500 for managing agent reserve schedules is shown. In this embodiment of the system architecture 500, two different users are illustrated: agents and administrators. The first user discussed is the agent. In particular instances, the agent may access a portal 530 via a fixed location processing device, such as their workstation. While in other instances, the agent may be off-duty and may use a mobile device such as a smart phone 520 or tablet to access the portal 530. That is, the agent may use any such devices to review and edit their reserve schedule. The various wireless infrastructure components for effecting the connection 503 to the Internet 123b are not shown. In many instances, the agent may receive a recall invitation during their off-hours and may find it convenient to be notified by a smart phone, as opposed to having to find a stationary computer.

The other type of user may be the contact center administrator. The administrator may also use a mobile device, but in many instances may use a fixed-location computer 525 as shown that is typically located in the contact center. The infrastructure for effecting the connection 507 is not shown, but may include a LAN in the contact center.

Both types of users access the portal 530, which may be a web server or host computer with functionality integrated into the WFM 155. For illustrating the concepts herein, the portal 530 is shown as a separate logical entity. The portal 530 may access the WFM 155 via connection 502, which may be a LAN. The WFM 155, in turn, may access and control the reserve schedule database 510 via connection 506 and the primary schedule database 515 via connection 508. In particular embodiments, these databases 510, 515 are integrated into a single database, and may be further integrated into the WFM 155 system. However, for purpose of illustration, these are shown as distinct entities.

In one embodiment, access to the primary schedule by a user occurs via the portal 530 and the WFM 155. In particular instances, the portal 530 (or the WFM 155, depending on the embodiment) allows read-only access of the primary schedule to the agent (and only for that agent's schedule), whereas the administrator may be granted additional privileges. Either the portal 530 or the WFM 155 may grant the agent additional privileges with respect to accessing the agent's reserve schedule, whereas the administrator may be limited in modifying the agent's reserve schedule.

In some embodiments, the portal 530 may even allow an agent to access the reserve schedule database 510 directly via connection 504, bypassing the WFM 155. One skilled in the art will recognize that different architectures can be defined to accomplish the functionality indicated. This embodiment uses a portal 530 to authenticate the user, determine whether they are an agent or administrator, and grant the appropriate read-only or read-write privileges depending on which database 510, 515 the user is accessing. Other embodiments may integrate these functions and the portal 530 into the WFM 155 and may integrate the reserve schedule and primary schedule that is manage by a single entity.

The above system architecture 500 allows the agent to control the generation of the reserve schedule, review the currently defined reserve schedule, and update the reserve schedule to reflect changes in availability for recall. In various embodiments, the portal 530 may provide other functions associated with the reserve schedule database 510. For instance, it may provide the aforementioned GUI 400 of FIG. 4, along with values for the agent's acceptance rate and/or priority rating. This may involve the portal 530 querying the WFM 155 for certain information to accomplish these functions. In addition, if the agent requests to view their primary schedule, edit their contact information, or view pending recall requests by the contact center, this information can also be provided to the agent via the portal 530 in various embodiments.

### Triggering Process Flow

Recall from the previous discussion that once the reserve schedule database 510 has been established, it can then be used to address an agent resource deficiency during operation of the contact center, or prior thereto. As noted previously, this requires the contact center to have the triggering mechanism to ascertain 1) if additional agent resources are required, and if so, 2) how many and when are these agent resources required. There are a number of triggering mechanisms that can be defined in various embodiments for determining these aspects. A process flow for one embodiment illustrates the basic triggering framework and alternatives that modify this framework are further identified.

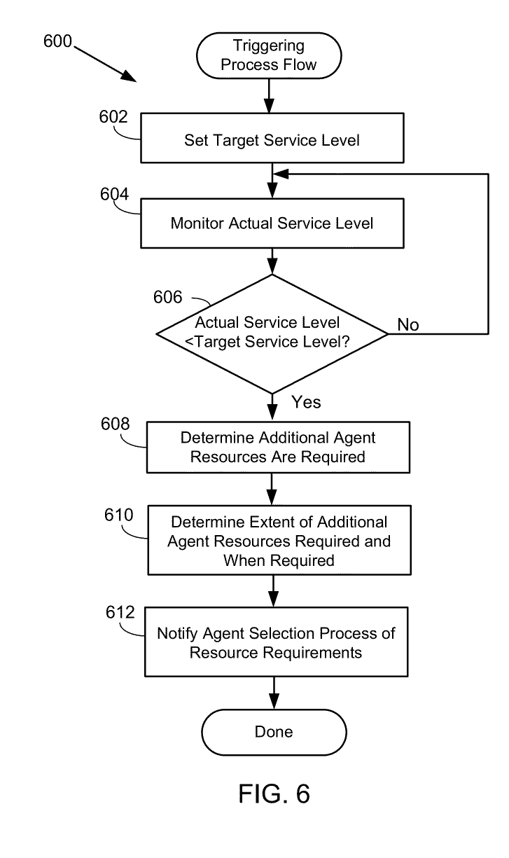

Turning to FIG. 6, the triggering process 600 begins in operation 602 with setting a target service level for incoming calls. For purposes of illustration and not limitation, it is assumed that incoming calls are assigned a service level so that 80% of the inbound calls are targeted to be answered within twenty seconds. However, as one of ordinary skill in the art understands in light of this disclosure, other service level parameters or values could be applied as key performance metrics to determine an agent resource deficiency. Continuing on, the actual service level is monitored during the operation of the contact center in operation 604.

If it is determined that the actual service level meets or exceeds the target service level in operation 606 (thus indicating there is no service level deficiency), then the process 600 loops back to operation 604 and continues to monitor the actual service level. If the actual service level is less than the target service level, then the process 600 proceeds to operation 608. At this point, in particular embodiments, a determination may be made as to whether the condition is temporary or an aberrational event that warrants allocation of additional agent resources. If the condition is temporary, then the process 600 loop backs to operation 604 (not shown). Various definitions are possible as to what constitutes a temporary condition versus a condition that warrants requesting additional agent resources. A threshold level may be defined along with possible minimum duration value for ascertaining that additional resources are required.

In operation 610, the extent of the additional agent resources required is determined along with when the agent resources are required. In this instance, the determination may indicate the number of agent resources needed for one or more time periods. In addition, the determination may further include information on what skill levels or other parameters are required by the additional agent resources. In particular embodiments, the time period used may be based on the smallest time period that the WFM can schedule resources. Thus, if the smallest scheduling period is fifteen minutes, then the time period indicated for additional agent resources may be multiples thereof, e.g., fifteen, thirty, or sixty minutes. An exemplary output for the determination could be a file or data structure delineating additional agents required for each hour during the identified period. For example, the file could indicate three agents are required at 3:00-4:00 p.m., four agents are required at 4:00-5:00 p.m., and six agents are required at 5:00-6:00 p.m. A certain skill level or other agent qualifier could also be included.

The next operation 612 occurs with providing the file or data structure indicating the required agent resources to the agent selection process. The agent selection process, discussed next, receives the output file or data structure and uses the information provided to select which agents are to be invited to be recalled to meet the determined need. The process 600 then completes.

There are a number of different approaches that may be use for detecting a deficiency that can be used in various embodiments. For instance, one approach is disclosed in U.S. Pat. No. 6,724,884, entitled Call Management System Using Fast Response Dynamic Threshold Adjustment. This approach allows a threshold to be defined before determining that additional agent resources are required. It can be appreciated that a single occurrence of a service level deficiency may not warrant trigging the recall of agents. Therefore, it may be necessary to ensure that the deficiency is sustained and significant to warrant recalling agents.

Another approach for determining there is an agent and/or service level deficiency is described in pending U.S. patent application Ser. No. 13/688,716, entitled Revising Outbound Forecasts and Corresponding Schedules Based on Performance Data, filed on Nov. 29, 2012, the contents of which are incorporated by reference for all that they teach. This application details using performance data associated with the execution of a current campaign for the purpose of revising a prior forecast and agent schedule for the campaign to ascertain whether additional agent resources are required.

Another approach for determining an agent deficiency can be based on conventional forecasting algorithms that indicate required agent resource levels in instances in which the agents have already been scheduled. In such instances, it may not be possible to generate a new agent work schedule and therefore this information is used to recall agents to meet the deficiency. For example, twenty agents are assigned to a campaign for the next two weeks. A conventional forecast determines that at certain times twenty-three agents will be required during the campaign. Rather than generating a new schedule, the resource deficiency is address by accessing the reserve schedules to identify the agents to be recalled for the necessary times.

Another approach for determining an agent deficiency is to monitor other forms of performance indicators or service metrics. For example, an agent utilization metric is commonly used in contact centers that measure the utilization of agents. It has been commented that agents should operate at a certain level of utilization so that they are busy, but are not too busy as to be susceptible to “burn out.” For example, it is reported that agents working at 90% utilization are susceptible to being over-worked. Thus, some contact center operators may define a utilization threshold at which point additional agents may be scheduled to work to help lower the utilization below the threshold. Other metrics, such as the number of calls handled, can be used. If a target level of calls handled per hour is not being met, then a deficiency could be indicative of a need to add agents. Further, a deficiency may be identified as a result of agents not reporting or logging into work as expected, or not completing a shift.

Another approach for determining an agent deficiency is via the WFM 155. For instance, the WFM 155 may know that a certain number of agents are required at certain times, and capabilities in the WFM 155 may allow agents to report in sick at the beginning of a shift (or allow other indications of a “no-show”). In this case, the WFM 155 may be able to identify when there is an agent deficiency and it may further be able to identify the times when the agent will be unavailable.

Finally, another approach for determining agent deficiency is a manual approach. The contact center administrator may determine by any number of manual means that an agent deficiency is present. For instance, the administrator may note that agents are late in reporting to work, have called in sick, or otherwise must leave or are unable to work during their scheduled shift. The administrator could determine that an agent deficiency exists by monitoring and analyzing service metrics and may also determine how many agents are required and when they are required. Adverse weather, disaster conditions, or other circumstances could result in a large number of agents being unable to attend work or cause an increase in call volumes. In such circumstances, the administrator may manually determine there is an agent deficiency. An appropriate GUI could be defined allowing the administrator to indicate the deficiency and input these required number of agent resources in lieu of an automated triggering process. In some embodiments, the administrator may manually review the aggregate reserve schedule and determine which agents are eligible to be sent a recall invitation.

### Agent Selection Process

The agent selection process involves identifying agents to fulfill the agent resource deficiency. In other words, this process identifies the agents to be recalled. The process can vary widely in embodiments as a large number of different rules can be defined for how agents are selected.

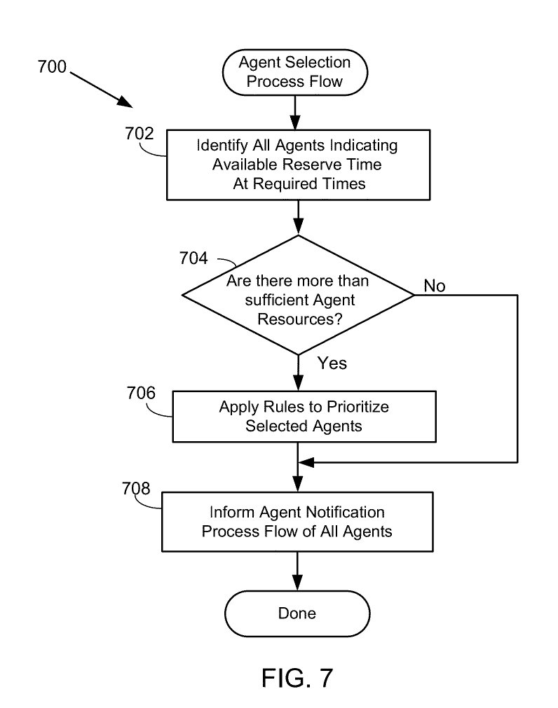

A high level description of one embodiment of the process 700 is shown in FIG. 7. This process flow does not depict all the various types of rules that can be applied, but illustrates how different rules can fit within the overall process 700. The process 700 begins after receiving input that indicates how many agent-hours are required and at what times.

The first operation 702 is to search the reserve schedules to identify all the agents that have any reserve time that is coincident with the required intervals. An elementary example illustrates this aspect. Assume the triggering process 600 has identified that two additional agents (e.g., two agent-hours) are required between 5:00 p.m. and 6:00 p.m. on the current day. Further assume that the database shows that of twenty agents, fifteen have indicated some form of reserve time in their respective reserve schedule. Of the five agents that have not indicated any available reserve time, these agents can be disregarded. Focusing on the fifteen agents that have indicated available reserve times, suppose that five of the agents do not have any available reserve times in the 5:00-6:00 p.m. time frame. These agents can also be disregarded. This leaves ten agents that have reserve times that could contribute to the deficiency for the 5:00-6:00 p.m. time frame.

In operation 704, a test is performed to determine whether there are more candidate reserve agents than required to meet the need. If there are fewer agents identified in the reserve schedules than can meet the need, then this means that even if all the agents are recalled, it still would not be sufficient to meet the required demand. If this is the case, then all of the agents should be contacted. This is reflected by the process flow continuing to operation 708 where the notification process flow is informed of the list of identified agents.

If, however, in operation 704, there are more agents than needed to meet the need, then in operation 706 various rules may be applied to prioritize which of the identified agents should be selected. Returning to the example above, it was determined that there are ten agents that have indicated reserve times at the needed time period. (Recall that only two agents for the hour were needed.) Thus, a surplus of potentially available reserve agents exists. As a result, this may require application of one or more rules to identify which of the ten agents are to be selected since only two agents are needed.

The rules that may be applied in operation 706 to select or prioritize the agents can vary according to various embodiments. In addition, in particular embodiments, the rules may utilize information associated with the agents (e.g., in agent profiles) to prioritize one agent over another. The following is a non-exhaustive list of examples of information that may be used to determine which agents are to be invited to be recalled, or the order in which recall invitations are sent:
Seniority. Agents can be ranked via seniority as to whether they will be notified for recall. The seniority can be based on, for example, years of service or by job title. Those with greater seniority have priority over those with lesser seniority.
Pay Level. Agents can be ranked by their pay rate. In one embodiment, the lower pay rate agents have a higher priority so that identification of agents results in a least-cost result.
Contract. Agents may be associated with a union or employment contract so that agents associated with the union or contract may be prioritized relative to agents associated with other unions or contracts.
Skill. Agents may be prioritized by skill level. Agents with a compatible skill may be given priority over agents that do not have a compatible skill. The skill level can be measured by various metrics, including but not limited to: language spoken, product knowledge, areas of competency, completion of courses, etc.
Teams. Agents on a common or specified team may have priority over agents on another team.
Recall Priority Level. A priority level can be assigned to each agent by the contact center administrator indicating a relative priority for consideration for recall. Agents with a higher recall priority level are prioritized ahead of those with a lower recall priority level.
Recall Acceptance Rate. A recall acceptance rate can be calculated for each agent based on how often they accept a recall invitation. Those that accept recall invitations more often than others would have priority. For example, an individual accepting one of the last ten recall invitations would have a rate of 10%, whereas another individual accepting five of the last ten invitations would have a rate of 50% and therefore would have priority.
Contiguous Shift. Agents that can fulfill the agent deficiency by staying late or coming in early on an existing scheduled shift may have priority with respect to those agents that do not have an existing shift. In other words, if an agent can meet the deficiency by extending their existing shift as opposed to an agent who has to work on a day off, the former has priority over the latter. It may be unlikely to have an agent on their day off to come in for an hour or two, whereas an agent already working may readily agree to extend their shift by an hour or two. This rule may have different utility based on whether the contact center allows remote agents. Specifically, if agents can work-at-home, then being recalled for an hour or two is largely indistinguishable from their normal work pattern. However, an agent who has to commute to a contact center to work for an hour or two on their day off may not find the recall invitation worthwhile.
Minimization of Number of Recall Agents. This rule may select agents so that the number of agents recalled is minimized. For example, assume that a choice exists between selecting two agents, each contributing a portion of the required time and a single agent that can contribute all of the required time. More specifically, assume the two agents have indicated thirty minutes of reserve time are available for each so that the combination of the two yields one hour of agent time. However, another agent has indicated that sixty minutes (one hour) of reserve time are available. A rule could be defined so that the single agent has priority, since this would minimize the number of reserve agents recalled.
Break Shifting/Training Cancellation versus Agent Recall. A contact center may have a priority allocated for meeting an agent resource deficiency by first attempting to perform break shifting and/or training cancellation, as opposed to recalling agents during off-hours. For instance, the contact center may prefer to cancel or postpone agents scheduled for training over recalling agents during their off-hours.

In many embodiments, logical combinations of the above can be used to determine the rules for prioritizing agents. For example, a contact center may prefer to cancel existing training first, and if demand still exists, then select agents that have the appropriate skill level with the required priority. In another embodiment, the above requirements could apply but the rules further comprise selecting agents based on their seniority first and then by lower pay rate. Various logical constructs involving these and other rules can be fashioned to specify criteria to order a plurality of agents or further qualify agents to meet the deficiency.

For example, a rule can be construed that first selects agents having a compatible skill set. Then, of these agents, the agents are ordered by seniority. Then, the set of agents is filtered to remove any agent with a 25% or lower acceptance rate. Of the ones remaining, these are then sent the recall invitations. If an insufficient number of acceptances are obtained, then a new rule can be applied and used to identify another set of agents that are to be sent recall invitations.

In addition, the rules can define exclusions or negative preferences. Exclusions would eliminate agents, whereas negative preferences allocate a lower priority. For instance, a rule could be defined to avoid including agents who already are scheduled to work a certain number of hours per week. For example, agents classified as part-time may be limited to 30 hours/week or other agents working 40 hours/week may be excluded so as to avoid paying overtime hours to these agents. In such instances, agents having a primary schedule of less than 40 hours/week would have priority over those already scheduled to work 40 hours that week. In other embodiments, the metric could be hours worked/day. Or, exclusion could be defined to avoid selecting any agents associated with a specific employment contract. For example, a union contract may have a negotiated rule that no agents associated with the contract can be recalled. In that case, the selected agents would have to exclude all agents associated with the particular union contract. Another rule could exclude those agents with a poor recall acceptance rate.

In one embodiment, the output of the agent selection process is an ordered list of potentially available agents. The order of the agents may reflect each agent's relative priority to others. In other embodiments, the rules may be used to define which agents are in the set, without any indication of priority. For example, application of a seniority rule can be use to prioritize all eligible agents, wherein the order reflects the agent's seniority. This could be coupled with a foreign language skills set (e.g., ability to speak Spanish) that further defines who is eligible, but that does not by itself rank or prioritize the agents. In another embodiment, the application of a seniority rule could be defined to include all eligible agents (e.g., all agents with 3+ years of experience). In this case, any agent meeting the rule has the same priority as other agents in that group. The list of agents is then provided to the agent notification process whereby the agents can be notified for recall.

The rules mentioned above are for illustration purposes only and are not intended to limit the type of rules that can be specified. Those skilled in the art are able to develop a number of variations for agent selection rules and logical constructs to be applied in light of this disclosure. For example, weighting rules could be used to define an order, as opposed to excluding agents. In other words, the above mentioned criteria are used to define a relative weight for ordering agents as opposed to eliminating an agent from being recalled. Weighting rules serve to change the order of available reserve agents and do not by themselves exclude reserve agents. This may avoid situations where application of rules leads to reducing the pool of available agents to the point where there are no longer an excess of available reserve agents to meet the deficiency.

### Agent Notification

The agent notification process informs agents of a recall by sending them a recall invitation. In various embodiments, there are two main types of notification, and certain embodiments may employ one or the other, or a combination of the two. These types are parallel notification and serial notification. These can be effectively accomplished in different ways. In one embodiment, the difference involves whether an agent's acceptance of a recall invitation is processed in a certain order or in a first-come basis.

Parallel notification is essentially a broadcast-like form of notification wherein agents are effectively simultaneously informed of an agent recall. For example, a process of sending out a “blast” of emails would be considered parallel notification. (In this example, the split second sequencing of emails would not be considered a serial form of notification.) Similarly, a process for making the information available for all agents to view on a web site would be considered a form of parallel notification. Once an agent is notified, the agent may have the opportunity to respond (e.g., to accept the recall invitation). Once the agent responds, their response is processed in real-time (first-come basis) or in a defined order (based on a priority).

Serial notification is notifying agents in a time-sequenced manner for the purposes of receiving their responses in a time-sequenced manner. Thus, for example, Agent A is notified first and their response is received, and then Agent B is notified and their response is received, etc. This allows agents to be notified and their responses to be processed in a serial form. Typically, there is little practical application for notifying agents serially and then processing all of their results in parallel. Hence, serial notification lends itself to serial processing of the results.

The selected form of notification is typically related to determining which agents will be offered and allowed to accept an agent recall in instances when the potential for more agents to accept the recall exist then are needed to fill the need. In other words, if ten agents are recall eligible and only one agent is needed, it may be appropriate to prioritize agents for purposes of transmitting the notification. A practical consideration for serial notification is that an agent may not readily respond to a notification invitation quickly, and so a time limit may be assigned before the next agent is informed and allowed to respond. In the above example, if each agent is given one hour to respond, then it is possible that the tenth agent will not receive an invitation until ten hours after the first invitation. Thus, if the need for additional agent resources is fairly immediate (e.g., within the next several hours), then the serial form of notification may not be practical. Whereas, if the need is determined several days in advance, then the serial form of notification may be practical.

How the agents are notified and how their acceptances are received may dovetail with the structure of the agent selection list as described above. Namely, a prioritized agent selection list may be used with serial notification and serial processing of their responses. However, a prioritized agent selection list could also be used for parallel notification and prioritized processing of responses. For example, in one embodiment, agents may be notified in a serial manner. That is, Agent A is notified first, then Agent B is notified second, then Agent C is notified third, etc., in which the order of notification reflects their priority. On the other hand, notifying agents in parallel and processing responses as they are received negates any form of priority since lower priority agents could respond before higher priority agents. However, in another variation of parallel notification, the responses received are only considered after a response window has closed, and then the responses may be analyzed in terms of priority.

Further, various combinations of serial and parallel notification are possible in particular embodiments. For example, a first group of five agents could be notified in parallel and their responses processed with a time limit of one hour. Then, a second group of five agents could be notified in the next hour, etc. This reflects parallel group notifications that occur serially at the group level.

In other embodiments, non-prioritized agent lists are determined and notification and response examination occurs in parallel. For instance, in one embodiment, after a time period in which responses are allowed, the agent responses are prioritized using an acceptance rate value or priority value (or any of the aforementioned rules). For example, agents with the highest acceptance rate are processed first and so forth. This approach simplifies the notification process (e.g., it is parallel notification with a limited window to respond) but yet allows a priority to be assigned to the responding agents. In this embodiment, an agent does not know whether their acceptance of the invitation is counter-accepted by the RAMS until a confirmation is provided to the agent. For example, ten agents may respond to the invitation and the first five are processed and meet the demand. Accordingly, the remaining five are notified that their acceptance to the recall is, in fact, rejected or waitlisted by the system. In this embodiment, the notification of the recall invitation is more accurately referred to as an offer to the agent to indicate their willingness, as opposed to a request to accept the invitation.

Depending on the embodiment, the form of the agent notification can occur via any number of individual communication means, such as for example, email, text messages (e.g., short message service), or automated telephone calls. For instance, in one embodiment, the communication can be via an IVR as described in co-pending U.S. patent application Ser. No. 13/665,298, entitled “Fulfilling Staffing Requirements via an Interactive Voice Response System,” and filed on Oct. 31, 2012, the contents of which are incorporated by reference in their entirety. In instances when an email is sent, the email may include a link to a web site in the portal 530 containing additional details with respect to the invitations. For example, the email providing the link to the web site may be used by agents to access additional information on the site. Further, the portal 530 may maintain an agent profile that includes email address information for each agent that the agent can update as necessary.

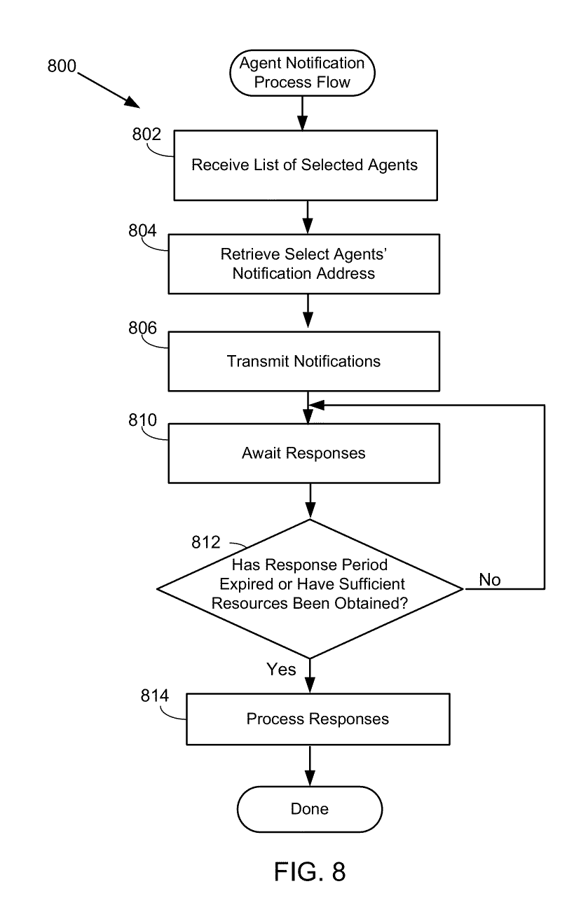

The above communication means are typically well-suited for either serial or parallel notification. However, for parallel notification, the communication means (e.g., emails, text, or phone calls) are largely sent in a virtually simultaneous fashion to be considered as parallel notification. As evident, there are a number of combinations and techniques that can be used in various embodiments to inform the appropriate agents of the recall, solicit their responses, and analyze their responses with respect to any remaining resource need. For example, one embodiment of the flow for the notification process 800 is shown in FIG. 8. It is presumed that the selected agents were based on a priority rule. This embodiment incorporates a parallel notification of the indicated agents and after a time window the agents' responses are analyzed in priority order.

Thus, turning to FIG. 8, the process 800 begins with receiving the list of selected agents in operation 802 that is presumed to be ordered in terms of priority for this embodiment. Further, it is presumed that there are more potential agents available than are needed to meet the demand. Alpha-numeric based address information for the selected agents is retrieved in operation 804, and different agents may prefer to have different forms of notification sent to them. This preference can be stored in a profile. Next, a notification is transmitted to each agent in operation 806. In this embodiment, the notifications are transmitted in parallel to all the agents in the list. Thus, even though the list is in priority order, the notification is in parallel.

Responses are awaited in operation 810. The responses are not necessarily processed in real-time as received. Failure to respond to the invitation results in a presumption that the agent has declined the invitation. Agents may further explicitly accept or reject the invitation. In this embodiment, the responses are collected for a particular time period or until sufficient agent responses have been received that meet the agent deficiency. Which operation is applied may depend on various factors in various embodiments. For example, if time is of the essence, responses may be analyzed on a first-come basis. Thus, in operation 812, a test determines whether the response period has expired or whether sufficient resources have been obtained. If the answer to both is no, the process 800 loops back to operation 810 to await and collect further responses. If the time window has expired and/or sufficient responses have been received to meet the agent deficiency, then the responses are processed in operation 814.

In this embodiment, the responses may be analyzed using the agent priority indicated in the agent selection list. Thus, the highest priority agent's response is analyzed first and the reserve time associated with this particular agent is credited to the deficiency amount if the agent's response indicates the agent is willing to be recalled. For example, if the agent deficiency requires three agent-hours between 2:00 p.m. and 3:00 p.m. and the responding agent has indicated a reserve hour is available then the pending deficiency amount is reduced to two agent-hours. The next highest priority agent's response is analyzed, and if they accept, then the deficiency is reduced by the number of hours that this next highest priority agent can provide, and so forth. In this example, after the third acceptance, the deficiency is met. Therefore, if a fourth agent's response exists, this response may not be needed since the deficiency between 2:00-3:00 p.m. may have been fulfilled. Thus, each response in priority is processed and the deficiency needs are updated before processing the next response. Once all the agent responses are processed, then the process 800 is completed.

Accordingly, in various embodiments, once sufficient reserve agent resources have been obtained to meet the deficiency, various updating of schedules and systems may occur. Recall from FIG. 2 that a master schedule for each agent may be maintained in which the master schedule stores both the primary schedule and the reserve schedule for the agent. The reserve schedule is the time that the agent has indicated as being potentially available to work. Once the agent accepts the invitation to work certain reserve time, the reserve time is converted to working time. This time can also be referred to as “converted reserve time” or “recall time.” In particular embodiments, the converted reserve time defines the agent's recall schedule and this schedule indicates the time when the agent is expected to work during their off-hours. The master schedule notes the converted reserve time, which can be done in a number of ways. For instance, in one embodiment, converted reserve time may be indicated in the agent's master schedule as working time with an additional indicator signifying that the time is converted reserve time. In various embodiments, the updated master schedule is available for the agent's review using any of the existing tools provided by the contact center to the agent for reviewing the agent's schedule. In addition, in particular embodiments, the agent may log into the portal 530 and review the agent's reserve schedule stored in the reserve schedule database 510.

Depending on the embodiment, the system component maintaining the master schedule may be the WFM 155. In these particular embodiments, the WFM 155 may update the master schedule for an agent to reflect converted reserve time. In addition, in particular embodiments, the WFM 155 may also incorporate modules which perform the various aforementioned triggering, selection, and notification processes.

In various embodiments, an administrator may also review a summary status after the agent notification process 800 has completed. In these particular embodiments, the purpose of the summary status is to provide the administrator with an indication of whether sufficient reserve agent capacity was obtained to meet the deficiency. The summary status can be presented to the administrator in a variety of formats, and the format can be tailored to meet the purpose of the information to be conveyed. For instance, in one embodiment, there are several types of information that the administrator may find useful. First, the administrator may desire to know the nature of the agent resource deficiency as well as how it was determined. The administrator may be informed of the extent (quantification) that agent resources were found to be deficient and at what times. This may necessitate presenting the deficiency in terms of agent-hours at certain times using minimum incremental reporting periods. Further, the administrator may wish to know on what basis the deficiency was reported. For instance, in particular embodiments, a deficiency can be classified as “real-time” or forecasted. In these embodiments, “real time” could be defined as pertaining to the current shift or day, whereas forecasted is a projected deficiency (often in advance of the current shift or day). The administrator may then also view when reserve times are available and to what extent that sufficient agents have been recalled to meet the deficiency.

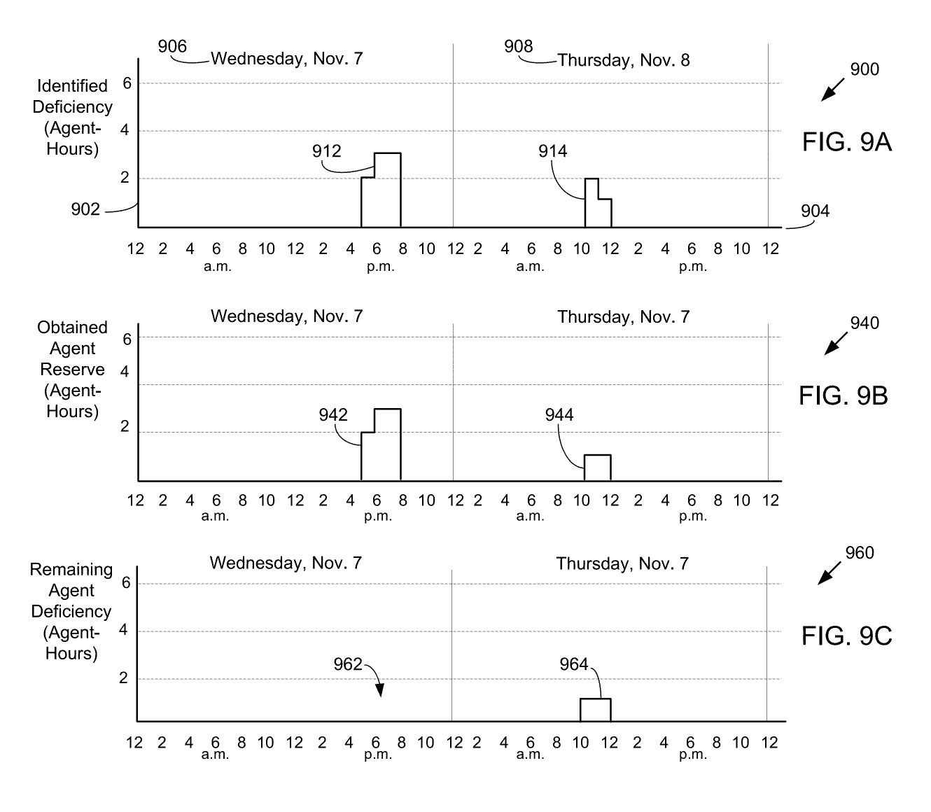

One graphical format for presenting such information uses a timeline 900 specifying the resource deficiency over a forecasted time period, as shown in FIG. 9A. This timeline 900 illustrates resource deficiencies over a two-day period 906, 908, namely Wednesday, November 7th and Thursday, November 8th. This could be, for example, the result of the deficiencies determined for the schedule for the upcoming week. However, in other embodiments, other formats may be presented such as, for example, on a weekly basis.

The vertical axis 902 represents the agent-hours in the identified deficiency and the horizontal axis 904 represents the time-of-day when the deficiency exists. The granularity of the time-of-day is marked in two-hour increments. However, the resource deficiencies are determined and reported on an hourly basis. Other embodiments may report the deficiency on a thirty minute, fifteen minute, or other time period basis.

In FIG. 9A, a first deficiency 912 is reported on Wednesday from 5:00 p.m. to 8:00 p.m. and a second deficiency 914 is reported on Thursday from 10:00 a.m. to 12:00 p.m. Specifically, the first deficiency 912 reports a deficiency of two agent-hours between 5:00 and 6:00 p.m. and a deficiency of three agent-hours between 6:00 and 8:00 p.m. The second deficiency 914 reports a deficiency of two agent-hours between 10:00 and 11:00 a.m. and a deficiency of one agent-hour between 11:00 a.m. and 12:00 p.m. Thus, FIG. 9A provides a quick visual reference of when and to what extent agent deficiencies exist.

FIG. 9B provides a timeline 940 with a similar indication of the result of obtained agent reserve hours. In this case, the first line graph 942 indicates the agent reserve hours that were obtained between 5:00 and 8:00 p.m. on Wednesday. In this embodiment, two reserve hours were converted to working time between 5:00 and 6:00 p.m. and three reserve hours were converted to working time between 6:00 and 8:00 p.m. The second line graph 944 indicates the agent hours obtained between 10:00 a.m. and 12:00 p.m. on Thursday, which is one hour.

FIG. 9C provides a timeline 960 for the remaining or net result of the agent deficiency. In this case, there is no line graph in area 962 because the obtained agent resources have completely met the deficiency—hence the remaining deficiency is zero. However, the line graph 964 for Thursday shows that there is a one agent-hour deficiency that remains between 10:00 a.m. and 12:00 p.m. In other embodiments, an over capacity of obtained reserve hours could be indicated as well. Further, such areas could be highlighted or presented in different colors to bring them to the attention of the administrator.

In some embodiments, the graphs may be overlaid, may be represented using different colors, or may be selected as separate pages for individual viewing by the administrator. This allows the administrator to easily ascertain where the deficiencies were determined, what reserve capacity was found, and where there is a remaining deficiency. Other embodiments may also provide reports in a tabular form, a listing of reserve agents that have committed to being recalled, or those agents having available reserve time but did not commit.

Manual Overrides

In particular embodiments, the administrator may have capabilities to manually override reserve schedules and/or to initiate recall invitations. In one example, which continues with the scenario described in conjunction with FIG. 9C, the administrator may determine that agent resources are still required for Thursday between 10:00 a.m. and 12:00 p.m.

In this example, the administrator may access the portal 530 to review the reserve schedules for the various agents. Alternatively, the administrator may “mouse-over” (e.g., place a cursor over) the line graph 964 to see a list of agents that have indicated available reserve times. The list may indicate which agents have committed reserve time and which agents have not. This allows the administrator to contact or discuss with the agents who have not committed reserve time whether they can commit reserve time to meet the remaining need for Thursday between 10:00 a.m. and 12:00 p.m. If the administrator finds an agent who is willing to commit reserve time, then the administrator may use one or more appropriate interfaces to manually schedule the agent for this time.

In another embodiment, the administrator may initiate an invitation manually to agents (either those with available reserve times or all agents, even if they have not indicated any reserve times) and request that the agents assist by accepting the invitation for the remaining agent-hours. While in another embodiment, the administrator may simply schedule an agent for conventional scheduled work time for the deficient time, and thus bypass the recall invitation process. In other words, the administrator may be able to manually convert reserve time for selected agents.

Incremental Pay Adjustments

In some embodiments, reserve times may be associated with additional pay provided to reserve agents to serve as an incentive for the reserve agents to accept recall invitations. In these particular embodiments, the additional pay can be determined in a variety of ways such as, for example, defining a multiplier that increases the base pay of the agent for reserve time or defining a fixed flat rate bonus for reserve time. In particular instances, the level of the increment and form of incentive can vary based on the reserve time period. For example, reserve times that are less likely to be accepted or that have fewer eligible agents may have a higher multiplier than reserve times that are more likely to be accepted. Once an agent accepts an invitation, in particular embodiments, the reserve time is converted to working time and the appropriate payroll management systems are informed so that the correct pay can be calculated for the reserve agent (e.g., so that the additional pay may be added to the agent's base pay).

In some embodiments, agents may be expected to accept a minimum number of recall invitations for a particular time period (e.g., on a monthly basis) or convert a minimum number of reserve hours for a particular time period before receiving additional pay. Thus, an agent may be required to accept recalls at a conventional base rate and only receive the incremental rate once the minimum level of recalls is exceeded.

Agent Notification of Resource Deficiencies

It is possible that under various conditions, an anticipated agent resource deficiency will not be filled. For example, when the time periods and the level of an agent deficiency are determined, there may not be any reserve hours indicated in the reserve schedules or there may be an insufficient number of reserve hours indicated in the reserve schedules. Thus, in particular embodiments, the RAMS may initiate a broadcast message to one or more agents indicating that there is an unfulfilled agent resource need for certain time periods. This message may also indicate a link to access the portal 530 so that an agent may review and manage their reserve schedule. Further, the message may also indicate an incremental pay rate for the particular time periods as an incentive for agents to respond.

For particular embodiments, this message is slightly different from the recall invitation described above in that this message may be sent to agents that normally would not be eligible to receive such messages. For example, if an agent is normally off on Monday and has indicated that time as “unavailable,” then normally recall invitations for time periods on Monday would not be sent to the agent. However, because of the remaining agent deficiency, the RAMS could send out a broadcast recall invitation to all agents.

In response, agents could access their reserve schedules and indicate the corresponding time period (or a subset thereof) as reserve time. Accordingly, the RAMS could then subsequently issue another recall invitation to the agents having the corresponding time period. Alternatively, the RAMS could monitor the reserve schedules and as an agent changes their reserve time to fit the unmet need, the agent's reserve hours are processed with respect to the deficiency.

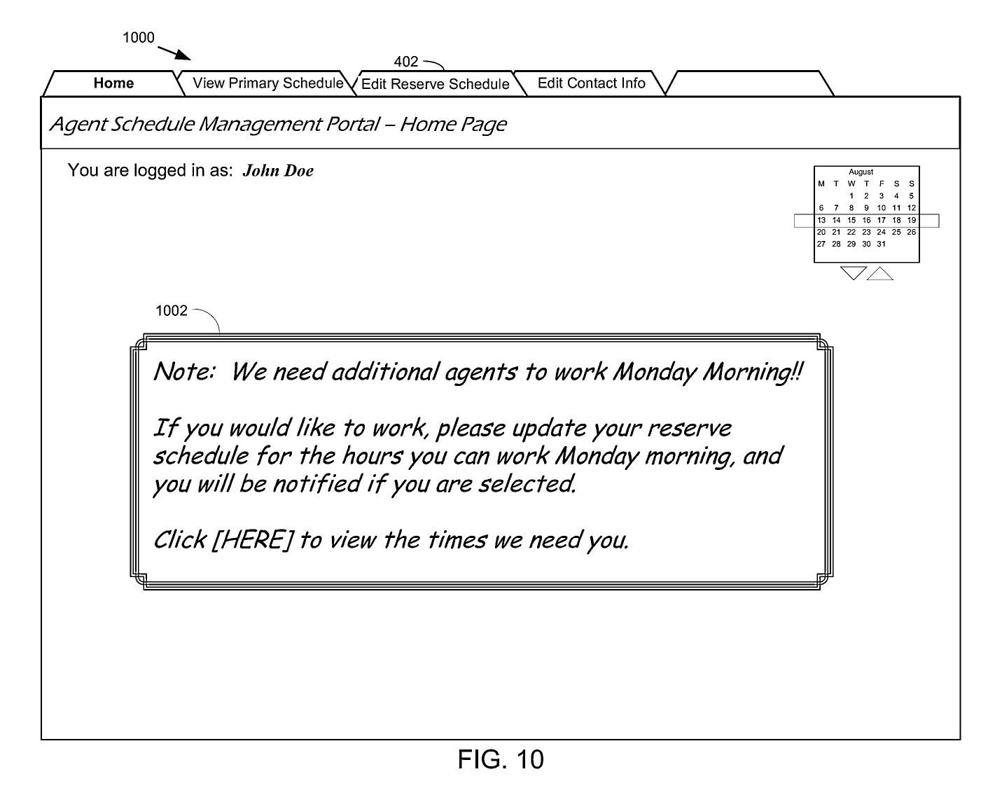

Another approach for informing agents of unmet needs can be via the home page of the portal 530 that the agents can access for managing their reserve schedules. For instance, after logging in, a home page 1000 as shown in FIG. 10 can be presented to an agent and a notice 1002 can be prominently presented to the agent indicating a need for agents at a certain time. The notice 1002 may indicate when additional agents are required and the specific time period(s). At this point, the agent may then select the tab 402 for editing their reserve schedule with respect to the unmet needs. Further, the agent may then be notified whether they are recalled or a subsequent invitation may be transmitted to the agent. In other embodiments, agents may instead be presented with a link to view the specific time periods.

The home page 1000 may be optimized for access by a smart phone, and hence the particular format of the home page 1000 may vary in other embodiments. The agent may receive notifications via text messages or email, and a link can be included to the agent's home page. This allows the agent to potentially skip the log-in process and may directly present the agent's master schedule and/or graphics indicating when the agent deficiency exists.

In some embodiments, the user can make themselves eligible for an unmet agent deficiency by accessing their reserve schedule, altering their reserve schedule to indicate the appropriate times as being reserve time, and then closing their home page and wait for a recall invitation. However, this approach requires a number of steps, and other embodiments may allow an notification to be presented to the agent indicating the unmeet hours, and provide a “I accept” button to the agent allowing the agent to be recalled in one step, even if all or portions of the agent's time are marked as “unavailable time” in the agent's master schedule. Essentially, invoking this function defines the needed time period as converted reserve time in the agent's master schedule. The RAMS essentially mimics all the steps that would otherwise have to occur in order to have the time converted reserve time indicated. This allows the agent to quickly accept a recall invitation without having to first modify their reserve schedule.

Dynamic Determination of Reserve Time Pay

In various embodiments, there may be instances in which a plurality of agents is invited to become recalled agents. In such instances, the responses from the agents (or the lack thereof) may be accommodated by adjusting the incremental pay associated with the reserve time(s) accordingly. For example, a lack of agents responding to an invitation may result in re-inviting the agents but at a higher incremental rate. Alternatively, it may be known that a large number of eligible agents are to be invited and that a plurality of positive responses is expected. In this case, each invitation may be transmitted with a qualifier that no incremental pay rate will be paid and that the agent will receive the agent's normal pay rate.

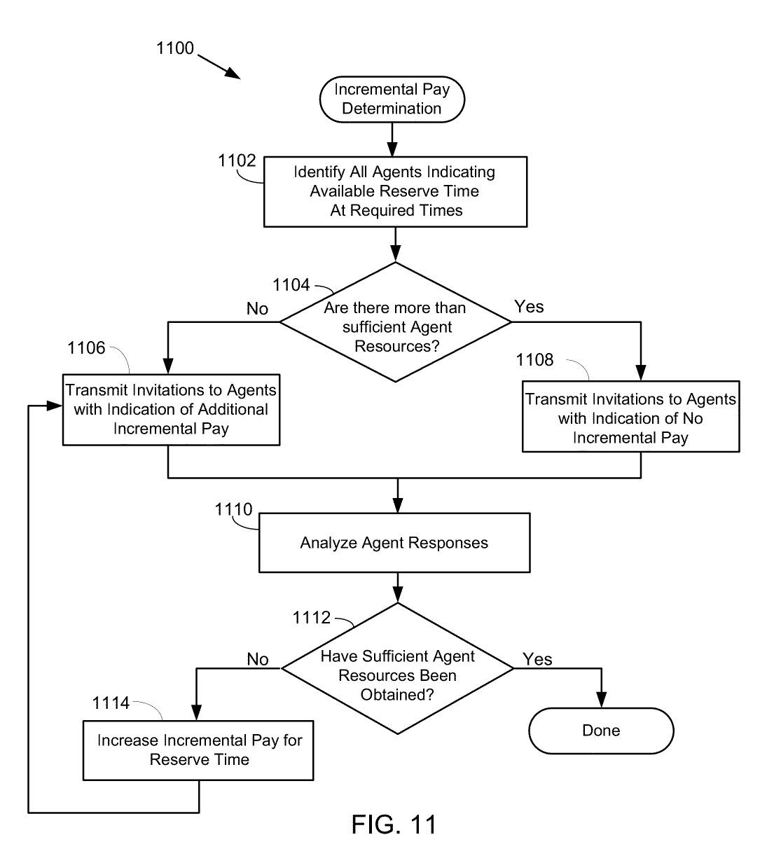

One embodiment of dynamically adjusting the reserve time pay is shown in FIG. 11. FIG. 11 illustrates a process flow for accommodating either a lack of responses or an expected plurality of responses. The process 1100 begins with identifying the agents that have available reserve times that match the required times in operation 1102. This is determined by accessing the reserve schedules for individual agents and identifying all the agents who could contribute to the deficiency. For each applicable time period, a determination is made whether it is expected that there are more than sufficient agent resources in operation 1104. For instance, in one embodiment, this may be determined by multiplying the number of agents by an expected response probability. For example, if ten agents have reserve times indicated in their reserve schedules for a given time period and past history suggests that a certain number will respond (e.g., 30%) to accept a recall for the given time period, then it can be predicted that at approximately three positive responses can be expected from sending these ten agents recall invitations. However, for other time periods, there may only be one agent who is eligible. Thus, given historical response rates, the number of eligible agents, and require resources to meet a deficiency during a time period, an expectation of whether there is likely to be a sufficient number of resources can be determined.

If in operation 1104, there are more than a sufficient number of agent resources expected to respond positively to meet the need, then in operation 1108 invitations may be extended to these agents with an indication that no incremental reserve time pay is involved. If, on the other hand in operation 1104, there are an insufficient number of agent resources expected to respond positively to meet the need, then in operation 1106 the invitations may be extended to these agents with an indication of incremented additional pay.

In operation 1110, the agents' responses are analyzed. Thus, in operation 1112, a determination is made as to whether a sufficient number of agent responses to meet the need has been obtained. If so, then the process 1100 is completed. If not, then the incremental pay for the reserve time is increased in operation 1114, and the process 1100 loops back to operation 1106 with the agents informed of the increased incremental pay. This looping back through the process 1100 may function as a form of bidding in particular embodiments, wherein the incremental pay offered is increased to entice agents into accepting the recall invitations.

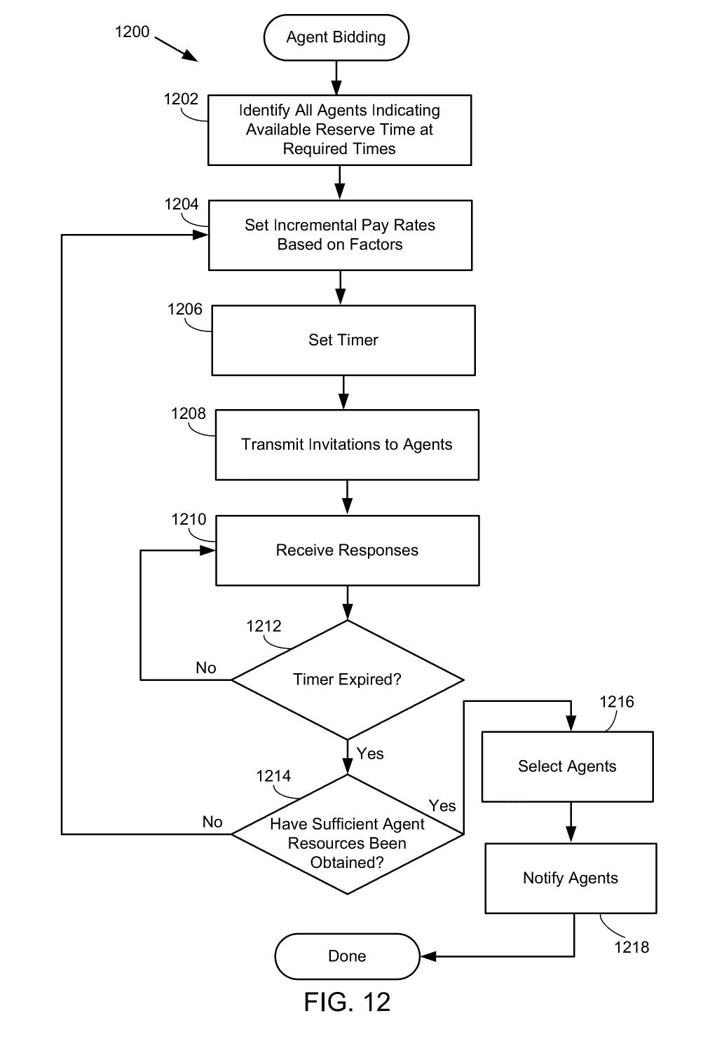

Turning now to FIG. 12, a process flow is provided for implementing agent bidding to be recalled according to one embodiment. That is, for this particular embodiment, the process flow involves setting incremental pay rates that may be applied to one or more time periods for which agents are needed to be recalled to address an agent resource deficiency. Eligible agents may bid to fill the needed agent resources to address this deficiency, wherein the bidding is based on incremental pay rates.

For example, an agent resource deficiency of three agent-hours may have been identified for a time period of 4:00 to 5:00 p.m. on Saturday, August 19^{th}. Therefore, in this example, three agents are needed to be recalled to work one hour each for this time period. Thus, looking now at FIG. 12, similar to the process 1100 just previously described, this process 1200 also begins with identifying the agents who have available reserve times that match the required times in operation 1202. That is, agents are identified who have indicated reserve time that includes the time period of 4:00 to 5:00 p.m. on Saturday, August 19^{th} in their reserve schedules.

The process 1200 then continues with setting incremental pay rates based on one or more factors in operation 1204. For instance, in particular embodiments, the factors considered in setting the incremental pay rates may include one or more of: (1) the number of eligible agents who could contribute to the deficiency; (2) the time period(s) in which additional agent resources are required; (3) the day(s)-of-the-week on which the time period(s) fall; (4) how far in the future do the time period(s) occur; and/or (5) the probability of agent acceptance to be recalled for the time period(s).

It is noted that, depending on the embodiment, the operation 1204 for setting the incremental pay rates may be performed manually, automatically, or based on a combination of both. For instance, in one embodiment, an administrator at the contact center may review the identified agents who have eligible reserve times and may manually set the incremental pay rates after considering various factors. These manually set incremental pay rates may be provided as input into RAMS and it may then carry out the remainder of the process 1200. While in another embodiment, the one or more factors may be translated into one or more rules that may be applied by the RAMS to set the incremental pay rates. For example, the contact center may implement a rule that a first incremental pay rate is to be set at 1× an agent's base pay rate (e.g., 1× multiplier) if the number of identified agents who have eligible reserve times exceeds fifty agents. While in another embodiment, a combination of using manual selection and having various rules automatically applied may be used in setting the incremental pay rates. In some embodiments, different multiplier rates can be offered to different subsets of agents. For example, lower paid junior agents may have a first multiplier rate, whereas higher paid senior agents may have a second multiplier rate. Those of ordinary skill in the art can envision multiple methods that may be employed for setting the incremental pay rates in light of this disclosure.

Thus, returning to the previous the example, three additional agent-hours are needed during 4:00 to 5:00 p.m. on Saturday, August 19^{th}. In this instance, ten agents have been identified who have reserve times on their schedules that could accommodate this particular time period. Further, it can be assumed for purposes of illustration that this particular time period occurs in the afternoon on a day when many agents are not typically scheduled to work. In addition, in this particular instance, three of the identified ten agents are currently scheduled to work from 8:00 a.m. to 4:00 p.m. on Saturday, August 19^{th}. Therefore, in this example, all of these factors are taken into consideration in setting the incremental pay rates that are to be offered to the ten agents as an incentive to accept the recall invitation. Specifically, the incremental pay rates associated with the invitations for this time period are set at multipliers of 1.5×, 2×, and 2.5× an agent's base pay rate. That is, one of the ten eligible agents may accept to be recalled to work during the time period and the agent may agree to be recalled at a pay rate that pays the agent 1.5 times the agent's base pay rate, 2 times the agent's base pay rate, or 2.5 times the agent's base pay rate. Therefore, for this particular process 1200, an agent not only indicates whether they agree to be recalled for this time period, but the agent also indicates at what incremental pay rate the agent is willing to accept to be recalled for this time period.

Returning now to FIG. 12, a timer is set to measure an amount of time the agents are given to respond to an invitation in operation 1206. Similar to establishing the set of incremental pay rates, the amount of time afforded to the agents to respond to an invitation may be based on one or more factors. For example, if invitations are to be transmitted on Friday, August 18^{th} at 3:00 p.m. to the ten agents with respect to being recalled for the 4:00 to 5:00 p.m. time period on Saturday, August 19th, the timer may only be set for two hours since the need to find three agents to be recalled for the time period is relatively high since the time period is occurring roughly twenty-four hours after the invitations are transmitted. Furthermore, similar to establishing the set of incremental pay rates, the operation 1206 for setting the timer may be performed manually, may be automated, or may involve a combination of the two depending on the embodiment.

Thus, in operation 1208, the recall invitations are transmitted to the eligible agents. That is, returning to the example, invitations are transmitted to the ten eligible agents that inquire whether each agent is interested in being recalled to work for one hour on Saturday, August 19^{th} from 4:00 to 5:00 p.m. In addition, the invitations ask the agents to identify the incremental pay rate multiplier (e.g., 1.5×, 2×, or 2.5×) they would be willing to accept to be recalled for this particular time period. Depending on the embodiment, the invitations may include additional information such as, for example, the total number of agent-hours needed for the particular time period (e.g., three agents to work for one hour each during the time period) and the total number of agents who have been extended the invitations (e.g., ten agents). Such information may allow an agent to evaluate how they would respond to the invitation and which incremental pay rate they may be willing to accept to ensure they are selected to be recalled.

Continuing on, in operation 1210, responses are received from the agents. As mentioned, a response received from an agent may indicate whether the agent is willing to be recalled for the identified time period(s) and if so, what incremental pay rate(s) the agent is willing to accept to be recalled for the identified time period(s). Thus, in the example, a response from one of the ten eligible agents indicates whether the agent is willing to be recalled to work during 4:00 to 5:00 p.m. on Saturday, August 19^{th} and if so, what incremental pay rate, 1.5×, 2×, or 3×, the agent is willing to accept to be recalled for this particular time period. It is noted that, in some instances, the response may also indicate the amount of the time the agent is willing to be recalled. For example, if two hours from 3:00 to 4:00 p.m. are needed to be worked on Saturday, August 19^{th} instead of just one hour from 4:00 to 5:00 p.m., then an agent may indicate that they are only available to be recalled for one of the two hours. Thus, in this instance, the response would also indicate the time that the agent is willing to be recalled to work.

At this point, the process 1200 continues to monitor the timer to determine whether the time to submit a response has expired in operation 1212. For example, in one embodiment, the timer is monitored every fifteen minutes to determine when the timer has expired. Once the time has expired, the process 1200 involves determining whether a sufficient amount of agent resources have been obtained to meet the agent resource deficiency in operation 1214. Thus, returning to the example, after two hours have elapsed since the invitations were sent to the ten eligible agents, the responses received from the agents during the two hours are evaluated to determine whether at least three of the ten agents have agreed to be recalled to work during 4:00 to 5:00 p.m. on Saturday, August 19^{th}. If an insufficient amount of agent resources have been obtained, then the process 1200 returns to operation 1204 and sets new incremental pay rates. For instance, in the example, if only a single agent has responded that they are willing to be recalled to work during 4:00 to 5:00 p.m. on Saturday, August 19^{th}, then a new incremental pay rate may be set at 3× as a further incentive to try and convince two of the remaining nine agents to agree to be recalled to work during 4:00 to 5:00 p.m. on Saturday, August 19^{th}. At this point, the process 1200 repeats by sending out new invitations that include the new incremental pay rate to the nine agents.

However, returning to operation 1214, if a sufficient amount of agent resources have been obtained, then the process 1200 continues with selecting agents to be recalled in operation 1216. For instance, returning to the example, if the responses received from the ten agents indicate that six of the agents are willing to be recalled, then three of the agents must be selected from the six to actually be recalled to work during 4:00 to 5:00 p.m. during Saturday, August 19^{th}. Depending on the embodiment, a number of factors may be considered in selecting which three of the six agents should be recalled. A factor that is generally considered is the incremental pay rate each of the agents is willing to accept in order to be recalled for the time period. Therefore, in this instance, one of the agents has indicated they are willing to be recalled at the incremental pay rate of 2.5×, three of the agents have indicated they are willing to be recalled at the incremental pay rate of 2×, and the remaining two agents have indicated they are willing to be recalled at the incremental pay rate of 1.5×. The criteria for selecting which agents to accept may be based on one or more rules that minimize the overall pay. Thus, in this instance, the two agents who have indicated they are willing to be recalled at the incremental pay rate of 1.5× are selected to be recalled along with one of the agents who has indicated they are willing to be recalled at the incremental pay rate of 2×. Other factors may be considered with respect to selecting which one of the agents who have indicated they are will to be recalled at the incremental pay rate of 2×. For example, each agent may also have an associated priority rating 432 that is used to select which one of the responding agents will be recalled.

At this point, the agents are notified as to whether they have been recalled in operation 1218. That is, in the example, the six agents are notified as to whether they have been recalled to work 4:00 to 5:00 p.m. on Saturday, August 19^{th}. In addition, the appropriate schedules are updated for the three agents who have been selected to be recalled. The agent bidding process 1200 is now completed.

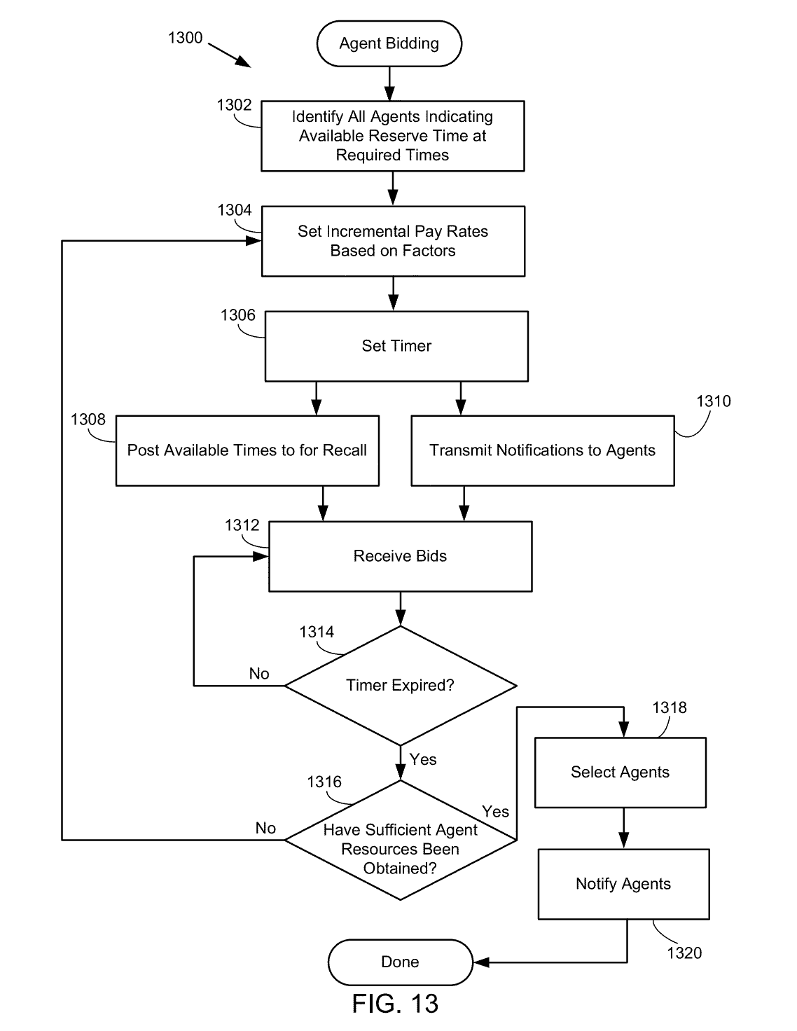

Turning now to FIG. 13, another process flow is provided for implementing agent bidding to be recalled according to a second embodiment. For this particular embodiment, the process flow involves posting the time period for an agent resource deficiency and allowing agents to view the posting and bid on being recalled to work during the time period. For instance, the posting for the time period may be provided on the portal 530 and/or a web page that agents may visit and bid on being recalled to work during the time period.

Still using the example described above with respect to the first process flow for implementing agent bidding, an agent resource deficiency of three agent-hours has been identified for a time period of 4:00 to 5:00 p.m. on Saturday, August 19^{th}. Thus, three agents are needed to be recalled to work one hour each for this time period. Similar to the previous process 1200, this process 1300 also begins with identifying the agents who have available reserve times that match the required times in operation 1302. It is noted that for this particular embodiment, the process 1300 involves reviewing the reserve times for agents in order to identify eligible agents to be contacted with respect to visiting the posting and possibly bidding on being recalled for the time period. An advantage of identifying the eligible agents as opposed to posting the time period and sending out a mass notification to every agent is that only the agents who have indicated an interest in possibly being recalled for the particular time period are notified, while other agents who are not interested in being recalled for the particular time period are not burdened with unwanted notifications. Thus, such selective notification may help to limit the number of notifications that need to be made and to better streamline the process 1300. Accordingly, for this particular example, ten agents are identified as having reserve times that match the time period of 4:00 to 5:00 p.m. on Saturday, August 19^{th}.

The process 1300 then continues with setting incremental pay rates based on one or more factors in operation 1304. Thus, in this particular instance, this process 1300 carries out this operation by applying one or more factors in similar fashion as with the bidding process 1200 previously described. That is, for example, the incremental pay rates may be set based on considering one or more factors such as: (1) the number of eligible agents who could contribute to the deficiency; (2) the time period(s) in which additional agent resources are required; (3) the day(s)-of-the-week on which the time period(s) fall; (4) how far in the future the time period(s) occur; and/or (5) the probability of agent acceptance to be recalled for the time period(s). Again, depending on the embodiment, this operation 1304 may be performed manually, automatically, or be based on a combination of both. Accordingly, in the example, the incremental pay rates are set at multipliers of 1.5×, 2×, and 2.5× of the agent's base pay rate.

At this point, a timer is set to measure an amount of time the agents may view and respond to the posting by placing a bid for being recalled to work during the time period in operation 1306. Similar to establishing the set of incremental pay rates, the amount of time afforded to the agents to view the posting and submit a bid may be based on one or more factors. Furthermore, similar to establishing the set of incremental pay rates, the operation 1306 for setting the timer may be performed manually, automatically, or may involve a combination of the two depending on the embodiment.

Thus, in operation 1308, a posting is provided for the time period. As mentioned, depending on the embodiment, the posting may be provided using a number of different mechanisms. For instance, in one embodiment, the posting is provided on the portal 530. Thus, an agent may log into the portal 530, view the posting, and bid on being recalled for the time period. While in another embodiment, the posting may be placed on a web page the agents may visit over the Internet to bid on the time period. In addition, communications may be transmitted to the eligible agents to notify them of the posting in operation 1310. For example, the eligible agents may be sent an email or text message notifying them of the posting and the amount of time the posting will be open for bidding. In particular instances, a link to the posting may also be provided in the communication.

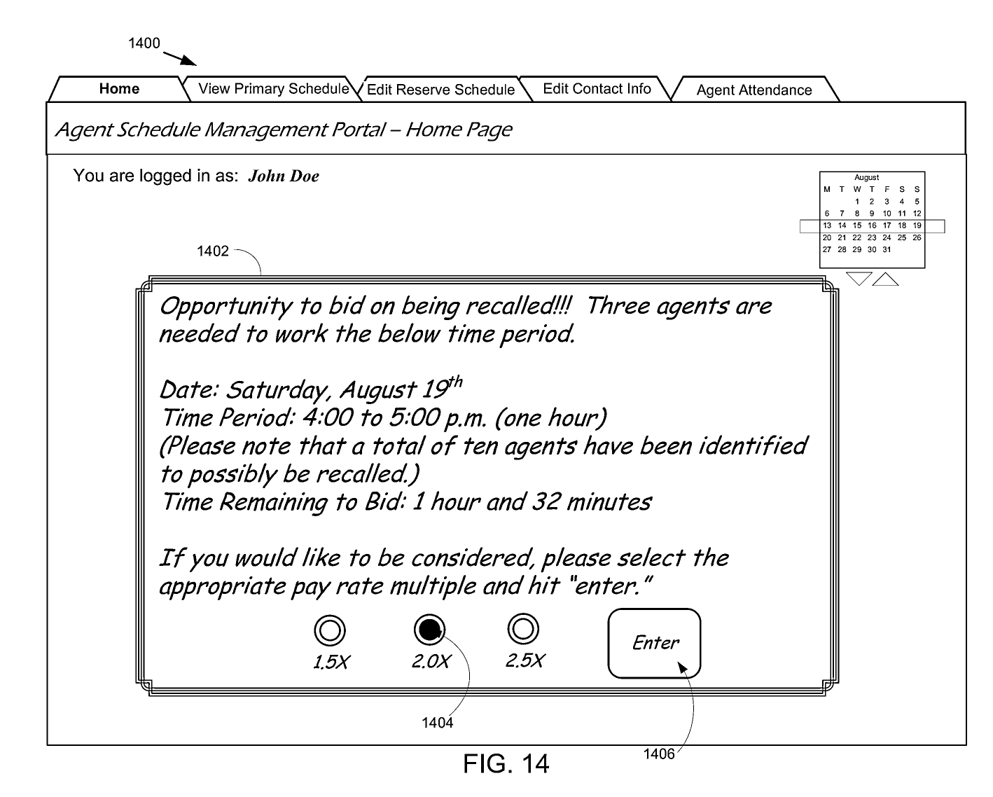

Turning now to FIG. 14, an embodiment of such a posting is provided on the home page 1400 of the portal 530 for 4:00 to 5:00 p.m. on Saturday, August 19^{th}. In this instance, the home page 1400 provides an announcement 1402 that an opportunity is available to bid on being recalled to work during this time period and that the remaining time to enter a bid is one hour and thirty-two minutes. Accordingly, the agent is asked to select an appropriate multiplier (in this instance, the agent has selected the 2.0× multiplier button 1404) and to hit the “Enter” button 1406. As a result, the agent places a bid to be recalled to work for one hour during 4:00 to 5:00 p.m. on Saturday, August 19^{th} at two-times the agent's base pay rate. It is noted that in some instances, the posting may also allow an agent to indicate the amount of time the agent is willing be recalled to work.

Retuning now to FIG. 13 and continuing on, in operation 1312, bids are received from the agents. Thus, in this instance, a bid not only indicates the agent is will to be recalled to work during the time period but also indicates what incremental pay rate (e.g., pay rate multiplier) the agent is willing to accept to be recalled for the identified time period. Thus, in the example, a bid is received from one of the ten eligible agents indicating the agent is willing to be recalled to work during 4:00 to 5:00 p.m. on Saturday, August 19^{th} at an incremental pay rate of 2×.

At this point, the process 1300 continues to monitor the timer to determine whether the time provided to agents to place bids has expired in operation 1314. Once the time has expired, the process 1300 involves determining whether a sufficient amount of agent resources have been obtained to meet the agent resource deficiency in operation 1316. Thus, returning to the example, after two hours have elapsed to allow the ten eligible agents to place bids, the bids received from the agents are evaluated to determine whether at least three of the ten agents have agreed to be recalled to work during 4:00 to 5:00 p.m. on Saturday, August 19^{th}. If an insufficient amount of agent resources have been obtained, then the process 1300 returns to operation 1304 and sets new incremental pay rates.

However, if a sufficient amount of agent resources has been obtained, then the process 1300 continues with selecting agents to be recalled in operation 1318. For instance, returning to the example, if the bids received from the ten agents indicate that six of the agents have entered bids to be recalled, then three of the agents must be selected from the six to actually be recalled to work during 4:00 to 5:00 p.m. on Saturday, August 19^{th}. The other three agents' bids are rejected. Depending on the embodiment, a number of factors may be considered in selecting which three of the six agents should be recalled. However, generally, a factor that is considered is the incremental pay rates each of the agents indicated in order to be recalled for the time period. Therefore, in this instance, two of the agents have indicated they are willing to be recalled at the incremental pay rate of 2.5×, three of the agents have indicated they are willing to be recalled at the incremental pay rate of 2×, and the remaining agent has indicated they are willing to be recalled at the incremental pay rate of 1.5×. Thus, in this instance, the agent who has indicated they are willing to be recalled at the incremental pay rate of 1.5× is selected to be recalled along with two of the agents who have indicated they are willing to be recalled at the incremental pay rate of 2×. The selection of these two agents may be based on other factors such as, for example, a priority rating 432 assigned to each of the agents.

At this point, the agents are notified as to whether they have been recalled in operation 1320. That is, in the example, the six agents are notified as to whether they have been recalled to work 4:00 to 5:00 p.m. on Saturday, August 19^{th}. In addition, the appropriate schedules are updated for the three agents who have been selected to be recalled. Specifically, the reserve times for these agents are converted to indicate working time. At this point, the agent bidding process 1300 is completed.

Break Shifting

In various embodiments, depending on the size of the agent deficiency and the number of agents, the deficiency may be addressed by rearranging existing breaks of the agents. This may also involve cancelling training. This method of addressing the deficiency may be referred to as “break shifting” and does not involve recalling agents during their off-hours. Further, since the breaks occur during the agents' regularly scheduled shifts, no reserve hours are consumed to adjust the agent resources and there may not be any incremental pay involved.

In one embodiment, break shifting may occur by the contact center notifying the agent of an update made to the agent's primary work schedule. In addition, depending on the embodiment, there may be limits as to how much breaks can be shifted or adjusted, but typically shifting a break by fifteen or thirty minutes is acceptable. Further, in many instances, the process does not involve transmitting any invitations, but merely involves transmitting the updated primary work schedule to the agent with a notification that a shift in a break has occurred.

For example, a communication such as a text message or email message could be sent to the impacted agents indicating that changes in their schedules have occurred. In some embodiments, the impacted changes may be summarized. For example, the message may indicate: “Notice—your schedule for Wednesday, August 15 has changed. You now have your lunch break scheduled for 12:30 p.m. You can visit your schedule at [web link address].”

Thus, in various embodiments, the information transmitted to an agent could be simply a notification (without an opportunity for the agent to accept or reject) of a schedule change or of a recall. While in other embodiments, the information transmitted to the agent could be a request for the agent to accept a recall and thus does offer an opportunity for the agent to accept or reject the recall. As used herein, an “invitation” refers to information transmitted to the agent regarding a recall in regard to an agent resource that allows the agent to confirm acceptance of the recall, whereas a “schedule change report” refers to information informing the agent of a schedule change without any opportunity to reject.

Agent Schedule Adherence Self Reporting

An agent is usually aware of when they are unable to adhere to a previously defined work schedule for various reasons. For instance, an agent may have a personal appointment that conflicts with their work schedule, a transportation issue that prevents timely arrival to the contact center work location, a health issue that arises, etc. Regardless of the reason, schedule adherence failures can generally be divided into three categories: late arrivals, no arrival (“no-show”), or early departure.

Depending on the circumstances, the agent may be aware in advance of the schedule adherence failure. For example, an appointment made with a doctor may be known by the agent several days in advance. While other causes may not be known by the agent until a relatively short time before the schedule adherence failure is to occur. For example, an agent suddenly becoming sick or having a sick child. Another cause of delay may be due to a transportation issue (automobile breakdown) and this may only be discovered on the way to work. Other issues, such as a sick child requiring pickup from school or day care can also occur with minimal lead time.

In particular embodiments, the RAMS can accommodate such circumstances by offering capabilities on the portal for the agent to report upcoming schedule attendance issues. This provides an efficient alternative to the agent manually reporting the situation to their supervisor, e.g., by a telephone call. This “self-reporting attendance” capability allows the agent to log-in and report an anticipated schedule adherence, whether it is a late arrival, no-show, or early departure. This can be accomplished by offering a tab on the agent's home page for allowing the agent to report anticipated adherence issues. This page could be optimized for access by a mobile device, such as a smart phone. This would facilitate the agent indicating an anticipated absence or late arrival when access to a personal computer is not readily available. If an early departure is required by the agent while on their work shift, the agent could access the page on the portal using their workstation.

The self-reporting attendance web page prompts the agent to identify the date (which would typically default to the current date, or the next scheduled work date for the agent), and then present the agent's work schedule. The agent is then prompted to indicate a time period that they expect to be absent. The agent could be prompted to associate the adherence condition with one of the above types, such as a late arrival, an early departure, or no-show. The agent could be presented various options for indicating a particular time period they will be absent or simply indicating the entire shift. Some options include predefined menu buttons for indicating:
a. No-show: this indicates that the entire shift will be missed. For example, this menu button may be used when the agent is sick and is expected to miss the entire shift.
b. Late arrival: this indicates a beginning portion of the shift is expected to be missed. A default time could be indicated (e.g., 1 hour late) which could be edited as appropriate by the agent. This menu button could be useful by the agent when circumstances prohibit the agent from arriving on time.
c. Early Departure: this indicates that the agent will be absent from the remaining portion of their shift. For example, an agent falling ill while at work or having to pick up a sick child from school would likely miss the remaining portion of their shift. In other embodiments, a specified time could be indicated, which indicates the agent plans to return back to their shift after the interruption.

The agent may be prompted to enter a reason code for the absence, and various codes may be defined for the missed time, including but not limited to: personal reasons, vacation, sick time, or unexcused time. The RAMS may then initiate the procedures above for contacting reserve agents to accommodate for the agent resource deficiency and may update the appropriate contact center components so that the absence is noted.

Minimum Time Blocks

In various embodiments, there may be a minimum time block defined for scheduling agents for working time periods and another for indicating reserve times. In some cases, these minimum time blocks may be different. For example, an agent may be scheduled to the nearest fifteen minute interval for their normal work shifts. However, it may be difficult to schedule reserve agents in fifteen minute intervals for reserve time. For example, agents may be unwilling to interrupt their day off to work a fifteen minute interval.

Thus, even though reserve times may be indicated in fifteen minute intervals, it may be necessary to define a distinct minimum amount of time (e.g., time block) that may be allocated as reserve time. For instance, this may be a minimum of thirty or sixty minutes time blocks. Thus, an agent may indicate reserve time from, for example, 2:00 to 5:00 p.m. Saturday afternoon, however this reserve time may be allocated as a minimum of a single hour of reserve time with additional amounts in fifteen minute increments. These parameters are usually defined by the application program defining the reserve agent management process. Other embodiments may employ rules indicating different minimum allocated times depending on the circumstances. For example, an agent extending an existing work shift may agree to accept an invitation for reserve time in fifteen minute increments, whereas an agent working reserve time on their day off may require a minimum one hour allocation of reserve time.

In other embodiments, when the agent accepts an invitation, the response may be qualified to further limit the needed time. For example, a recall invitation may be sent to an agent indicating a need for two hours (e.g., from 5:00 p.m. to 7:00 p.m.). The agent may respond by indicating that one hour (e.g., from 5:00 p.m. to 6:00 p.m.) can be provided. The RAMS may accept this response and attempt to have another reserve agent fill the remaining hour. Typically, the response will require a minimum time plus increments of the minimum period. For example, a response may require at least an hour and multiples of thirty minutes thereafter. An agent could then respond to this invitation by agreeing to work one hour, one hour and thirty minutes, or the full two hours. Of course, the RAMS may use this information in particular embodiments when selecting which responding agents to accept. For instance, the RAMS may give an agent that commits the full time preference over an agent who only commits a portion of the time.

Agent Reneging/Re-Notification

In some embodiments, an agent who has accepted an invitation to work off-hours may change their mind and renege. For example, an agent who is normally off each Saturday may have accepted an offer to work Saturday afternoon. However, for various reasons, the agent may no longer able to work Saturday afternoon as originally indicated. In this instance, the agent may be able to log onto the portal 530 and select a function allowing the agent to renege on their recall time commitment. A reason may be indicated, such as the agent is sick, their off-hours schedule has changed, etc.

In response, the portal 530 may re-initiate the process for determining whether other agents are available for the indicated reserve time. A subsequent re-invitation may occur that follows the process as described above. In addition, in particular embodiments, the portal 530 may act in response to receiving the renege request from the agent by lowering an acceptance rate 430 and/or priority rating 432 of the agent. These may be used when allocating reserve time for future requests made to the agent. Recall from FIG. 4 that an agent may have an acceptance rate 430 and/or a priority rating 432 that may be used to determine whether the agent or another agent should be invited for recall. Thus, an agent who reneges on a recall acceptance may have their acceptance rate 430 and/or priority rating 432 decreased so that next time the agent may not be contacted or may have a lower priority with respect to other agents. In some embodiments, an agent may be allocated a fixed number of renege allowances before their rate 430 and/or rating 432 are decremented. For example, an agent may be allocated a single renege allowance after which their rate 430 and/or rating 432 are reduced or downgraded. This serves as a mechanism for eliminating agents who are quick to accept invitations, but then habitually change their minds.

In particular embodiments, the impact of reneging may be related to how close to the reserve time that the agent reneges. Thus, in these particular embodiments, providing several days notice may allow the contact center to successfully rebid the reserve time, whereas reneging on the day of the reserve time may be difficult to replace the reserve agent and may require the contact center to increase the incremental pay to obtain sufficient agent resources on short notice. Therefore, in these particular embodiments, the downgrade to an agent's rate 430 and/or rating 432 may also take into account when the agent reneges relative to when the reserve time is required.

Reserve Time Credit Hours

In some embodiments, an agent may agree to be recalled for a set time in exchange for a corresponding reduction of hours during their regularly scheduled shift. In other words, an agent may agree to work reserve hours with the understanding that this time functions as a credit that can be applied to some other regularly scheduled hours (either hours that should have been worked in the past, but were missed, or hours in the future that are scheduled to be worked). For example, an agent may know that they have a doctor's appointment the following week and may expect to miss two hours of work. The agent may agree to work two additional hours after their shift today (or any other day in the current week) if the recall time can be applied for the following week.

Thus, in particular embodiments, applying a credit to reserve hours allows an agent to “balance” out the hours worked during a pay period (e.g., every two week) so that a relatively steady amount of hours are worked by the agent. That is, the agent can maintain a degree of control over their own work schedule by accommodating occasional events that may cause a conflict with their work schedule. Returning to the above example, an agent may receive their work schedule for the next two weeks and then discover a conflict with the following week for their doctor's appointment. In this instance, the agent could inform the administrator and the administrator could re-run a schedule for all the contact center agents. This new schedule would take into account the agent's planned two-hour absence. However, having the administrator repeatedly performing this process each time an agent expects a minor modification to their schedule may be burdensome and resource intensive. For example, re-running a new schedule and then distributing the new schedule to all the contact center agents would be disruptive as all the agents would then have to review their individual schedules for changes, and the agent scheduled to fill the missing time slot may then have a conflict. This could result in the whole process being repeated a number of times.

However, in particular embodiments, the administrator of the RAMS may instead review available reserve times in the reserve schedules for various agents and may issue invitations (either manually or automatically) to potentially available reserve agents to work the additional two-hour window. Provided an equally skilled agent is able to agree to work the reserve time, the net impact to the contact center operations may be minimal. The schedule change involves only the two agents and there is no need to rerun the primary schedules for all the agents in the contact center. In some embodiments, agents may be allowed to initiate this process via the RAMS.

In some embodiments, the agent requiring a planned absence or tardiness (“Agent A”) can negotiate individually with another agent (“Agent B”) to cover the missing time for Agent A. Once such agreement is reached, Agent B can review their schedule and indicate to the portal 530 that they are willing to work that time period (at the time period indicated by Agent A to Agent B). Essentially, Agent B indicates that time as reserve time on their schedule. At that point, Agent A knows that if the administrator then issues a manual invitation for that reserve time, an invitation will be sent to Agent B, and Agent B has agreed to accept the invitation. Thus, Agent A can facilitate finding a replacement for the required time without causing an unnecessary burden on the administrator or the operation of the contact center. Agent A can, in turn, agree to pick up an additional two hours if the opportunity presents itself, or use a credit previously earned.

The indication of whether recall time is an addition to the agent's schedule or is to be credited against future time on the agent's schedule may be made in various ways. For instance, in one embodiment, the agent may indicate via a checkbox in the response how they would like the recall time to be accounted for. For example, in lieu of a pay rate multiplier greater than 1, the agent may instead opt for receiving credit against a subsequent schedule. Other controls may be defined that limit certain agents to certain options. For example, senior agents may be offered greater flexibility, whereas junior agents may be limited. Or, part-time agents may have the flexibility, whereas full-time agents do not have the flexibility. This would allow agents to accept recall opportunities and have future time credited to avoid the contact center operator to pay overtime.

Treatment of Unreliable Reserve Agents

For the RAMS to function effectively, it is important in various embodiments that agents who indicate a willingness to be recalled during reserve times have a fair likelihood, if asked, to commit to being recalled. It is expected that in many instances reserve agents, when asked to be recalled, may be unable to commit. The likelihood depends on various factors such as, for example, how far in advance they are invited to be recalled, the time of day when they are recalled, etc. However, an agent who continually declines invitations during their indicated reserve times is termed as an “unreliable reserve agent.” The exact determination of when this level is reached varies from embodiment to embodiment.

In various embodiments, a large inventory of reserve times in reserve schedules associated with unreliable reserve agents may present a misleading indication to the contact center administrator of the status of available reserve times. Agents who continually decline recall invitations may see a reduction of future invitations as reflected by a reduced acceptance rate. An acceptance rate of 5% may reflect that the agent has only accepted one of twenty invitations. This affects the process of extending invitations to the unreliable reserve agent, but does not alter the indicated times on the agent's reserve schedule. When an administrator reviews the indicated reserve times in the master schedules, the presence of a large portion of unreliable reserve times can indicate a misleading indication of the inventory of available reserve times.

In one embodiment, a process in the portal 530 may periodically review reserve schedules and cull or remove reserve schedules from agents who have a very low acceptance rate. Removal of such schedules may present to the administrator a more accurate picture of the inventory of reserve times. This process may motivate agents to reflect a more accurate indication of reserve times that may be accepted by the agents, rather than broadly defining all of their off-hours as reserve times. In some embodiments, the RAMS may limit an agent's ability to define reserve time based on their low acceptance rate.

Automatic Recall of Agents

Agents scheduled for certain shifts are expected to log into the call handling system at their allocated times. In particular instances, an agent that fails to log-in is detected by the call handling system and the WFM is notified so that an appropriate schedule adherence rate of the agent can be updated. In summary, the WFM is aware when an agent is not logged in relative to a schedule of when the agent should be logged in.

In these cases, the WFM may initiate an agent recall in the RAMS based on the assumption that the agent will be late, or will not show up at all. In such instances, the RAMS and/or WFM may examine the reserve schedule database and determine whether there are any reserve agents that could be recalled. The RAMS and/or WFM can then automatically recall agents as previously disclosed in order to fill an agent “no-show” condition.

In other embodiments, the WFM may expect an agent to log in at a certain time, either at the indicated work time, or within +/−10 minutes of that time. If an agent log-in is not detected, then the RAMS and/or WFM may initiate a text message, email message, or voice call using an automated system to contact the agent to ascertain whether the agent is merely running late, or will not show up at all for their shift. The RAMS and/or WFM can use the response (or lack thereof) to appropriately schedule reserve agents. For example, if the agent is merely running late, the RAMS and/or WFM could contact reserve agents for an additional hour, but if the agent is unable to show up to work at all, or does not respond to the inquiry, then the RAMS and/or WFM could contact one or more reserve agents to cover for that agent's entire shift. In some embodiments, depending on the circumstances of the need for the agent recall, different rules could be applied for prioritizing which agents are recalled. For example, if agents are sick and unable to show up, the requirement for locating a suitable reserve agent to recall may be modified; e.g., criteria with respect to pay rate, seniority, skill set, etc. normally applied for recalling agents may be waived or altered in order to find suitable agent resources to cover the absent agent. In other words, the urgency of the need for agent recall can impact the rules for selecting which agents to recall.

### Exemplary Computer Processing Device

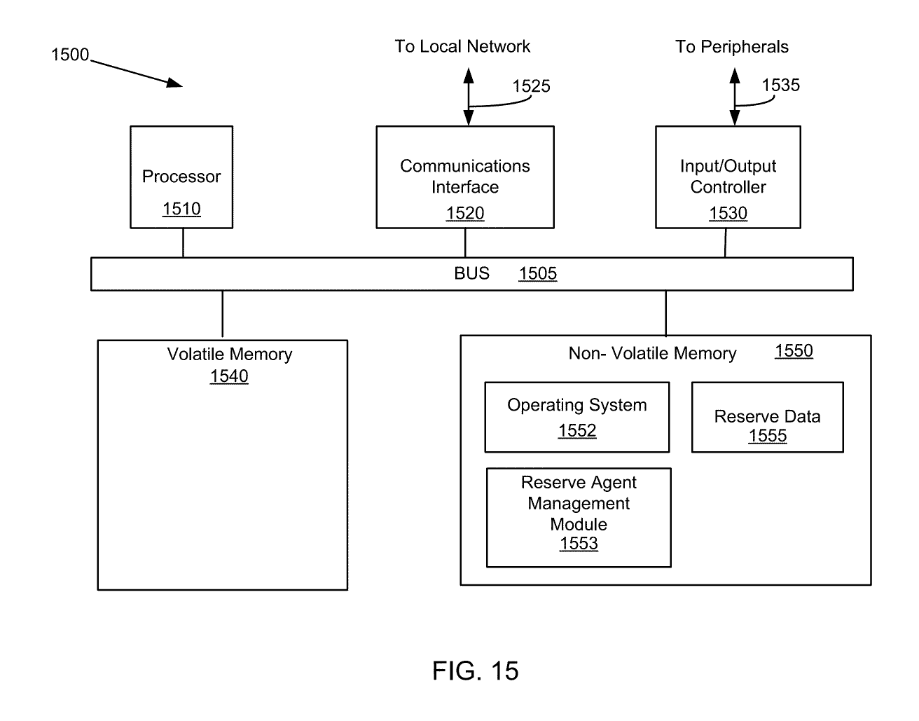

FIG. 15 is an exemplary schematic diagram of a computer processing system that may be used in an embodiment of the contact center architecture to practice the technologies disclosed herein. In general, the term “computer processing system” may be exemplified by, for example, but without limitation: a personal computer, server, desktop computer, tablets, smart phones, notebooks, laptops, distributed systems, servers, blades, gateways, switches, and the like, as well as any combination of devices or entities adapted to perform the functions described herein.

As shown in FIG. 15, the processing system 1500 may include one or more processors 1510 that may communicate with other elements within the processing system 1500 via a bus 1505. The processor 1510 may be implemented as one or more complex programmable logic devices (“CPLD”), microprocessors, multi-core processors, digital signal processors (“DSP”), system-on-a-chip (“SOC”), co-processing entities, application-specific integrated circuits (“ASIC”), field programmable gate arrays (“FPGA”), programmable logic arrays (“PLA”), hardware accelerators, other circuitry, or the like.

In one embodiment, the processing system 1500 may also include one or more communications interfaces 1520 for communicating data via the local network 170 with various external devices, including those shown in FIG. 1. In various embodiments, communication may be via wired, optical, or wireless networks (or a combination thereof). The communication may use a variety of data transmission protocols, such as fiber distributed data interface (FDDI), Ethernet, asynchronous transfer mode (“ATM”), or frame relay.

The input/output controller 1530 may also communicate with one or more input devices or peripherals using an interface 1535, such as, but not limited to: a keyboard, a mouse, a touch screen/display input, microphone, pointing device, etc. The input/output controller 1530 may also communicate with output devices or peripherals, such as displays, printers, speakers, headsets, banner displays, etc. These may be used, in part, to receive Administrator input, including for interacting with the manual agent selection module.

The processor 1510 may be configured to execute instructions stored in volatile memory 1540, non-volatile memory 1550, or other forms of computer readable storage media accessible to the processor 1510. The volatile memory may comprise various types of memory technologies, including, but not limited to: random access memory (“RAM”), dynamic random access memory (“DRAM”), static random access memory (“SRAM”), and other forms well known to those skilled in the art. The non-volatile memory may comprise various technologies, including, but not limited to: storage media such as hard disks, floppy disks, read only memory (“ROM”), programmable read only memory (“PROM”), electrically erasable read only memory (“EPROM”), flash memory, and other forms well known to those skilled in the art.

The non-volatile memory 1550 may store program code and data, which also may be loaded into the volatile memory 1540 at execution time. Specifically, the non-volatile memory 1350 may store one or more reserve agent management modules 1553 that may perform the above mentioned process flows and/or operating system code 1552 containing instructions for performing the process and/or functions associated with the technologies disclosed herein. The reserve agent management modules 1553 may also access, generate, or store the various schedules and related reserve time data 1555, including the data described above in conjunction with selecting agents, storing processing rules, etc., in the non-volatile memory 1550, as well as in the volatile memory 1540. The volatile memory and/or non-volatile memory may be used to store other information including, but not limited to: records, applications, programs, scripts, source code, object code, byte code, compiled code, interpreted code, machine code, executable instructions, or the like. These may be executed or processed by, for example, processor 1510. These may form a part of, or may interact with, the dialing list processing module 1553.

The technologies described herein may be implemented in various ways, including as computer program products comprising memory storing instructions causing a processor to perform the operations associated with the above technologies. The computer program product may comprise a non-transitory computer readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms). Such non-transitory computer readable storage media include all the above identified computer readable media (including volatile and non-volatile media), but does not include a transitory, propagating signal, nor does it encompass a non-tangible computer readable medium. Non-volatile computer readable storage medium may specifically comprise: a floppy disk, flexible disk, hard disk, magnetic tape, compact disc read only memory (“CD-ROM”), compact disc compact disc-rewritable (“CD-RW”), digital versatile disc (“DVD”), Blu-ray™ disc (“BD”), any other non-transitory optical medium, and/or the like. Non-volatile computer readable storage medium may also comprise read-only memory (“ROM”), programmable read-only memory (“PROM”), erasable programmable read-only memory (“EPROM”), electrically erasable programmable read-only memory (“EEPROM”), flash memory, and/or other technologies known to those skilled in the art.

### CONCLUSION

Many modifications and other embodiments of the concepts and technologies set forth herein will come to mind to one skilled in the art having the benefit of the teachings presented in the foregoing descriptions and the associated drawings. Therefore, it is to be understood that embodiments other than the embodiments disclosed herein are intended to be included within the scope of the appended claims. Although specific terms may be employed herein, they are used in a generic and descriptive sense only and not for purposes of limitation.

1. A method comprising the steps of:
determining an employee resource deficiency by at least one computer processor, the employee resource deficiency comprising a second quantity of employee resources needed to work during a future time period in addition to a first quantity of employee resources currently scheduled to work during the future time period;
identifying a first employee associated with a first reserve schedule by the at least one computer processor, the first reserve schedule comprising (1) one or more reserve time periods identified by the first employee, the one or more reserve time periods occurring during off-time that is outside one or more currently scheduled work shifts for the first employee and indicating when the first employee is potentially available to be recalled to work and (2) one or more unavailable time periods, the one or more unavailable time periods occurring during the off-time that is outside the one or more currently scheduled work shifts for the first employee and indicating when the first employee is unavailable to be recalled to work, wherein the first reserve schedule has a first reserve time period that coincides with the future time period;
identifying a second employee associated with a second reserve schedule by the at least one computer processor, the second reserve schedule comprising (1) one or more reserve time periods identified by the second employee, the one or more reserve time periods occurring during off-time that is outside one or more currently scheduled work shifts for the second employee and indicating when the second employee is potentially available to be recalled to work and (2) one or more unavailable time periods, the one or more unavailable time periods occurring during the off-time that is outside the one or more currently scheduled work shifts for the second employee and indicating when the second employee is unavailable to be recalled to work, wherein the second reserve schedule has a second reserve time period that coincides with the future time period;
transmitting a first invitation to the first employee, the first invitation inquiring as to whether the first employee is willing to work during the first reserve time period identified in the first reserve schedule that coincides with the future time period to fulfill at least a portion of the second quantity of employee resources needed to work during the future time period;
receiving a first reply from the first employee indicating whether the first employee is willing to work during the first reserve time period identified in the first reserve schedule that coincides with the future time period;
transmitting a second invitation to the second employee, the second invitation inquiring as to whether the second employee is willing to work during the second reserve time period identified in the second reserve schedule that coincides with the future time period to fulfill at least a portion of the second quantity of employee resources needed to work during the future time period; and
receiving a second reply from the second employee indicating whether the second employee is willing to work during the second reserve time period identified in the second reserve schedule that coincides with the future time period.

2. The method of claim 1, wherein the first invitation is transmitted to the first employee and the second invitation is transmitted to the second employee in response to the first employee and the second employee meeting an employee qualification with respect to at least one of having seniority, having an acceptable pay rate, having a needed skill level, having a willingness to work during time outside scheduled work shifts, having a certain number of hours already scheduled to work, having a certain number of hours already worked over a particular time period, being a member of a team, and having a time period already scheduled to work proximate to the future time period.

3. The method of claim 1, wherein the first invitation and the second invitation are transmitted at approximately a same time.

4. The method of claim 1, wherein the second invitation is transmitted to the second employee after the first invitation has been transmitted to the first employee and the first reply has been received from the first employee.

5. The method of claim 4, wherein the second invitation is transmitted to the second employee after the first invitation has been transmitted and the first reply has been received because the first employee has priority over the second employee.

6. The method of claim 1 further comprising the step of, in response to the first reply indicating the first employee is willing to work during the first reserve time period and the second reply indicating the second employee is willing to work during the second reserve time period, scheduling the first employee to work during the first reserve time period by the at least one computer processor as a result of the first employee having priority over the second employee.

7. The method of claim 1, wherein the first invitation is transmitted to the first employee and the second invitation is transmitted to the second employee based on a probability of the first employee being willing to work during the first reserve time period and the second employee being willing to work during the second reserve time period.

8. The method of claim 1, wherein the second invitation is transmitted to the second employee in response to the first reply indicating the first employee is not willing to work during the first reserve time period.

9. A non-transitory computer-readable storage medium comprising computer-executable instructions for causing at least one computer processor to:
determine an employee resource deficiency comprising a second quantity of employee resources needed to work during a future time period in addition to a first quantity of employee resources currently scheduled to work during the future time period;
identify a first employee associated with a first reserve schedule, the first reserve schedule comprising (1) one or more reserve time periods identified by the first employee, the one or more reserve time periods occurring during off-time that is outside one or more currently scheduled work shifts for the first employee and indicating when the first employee is potentially available to be recalled to work and (2) one or more unavailable time periods, the one or more unavailable time periods occurring during the off-time that is outside the one or more currently scheduled work shifts for the first employee and indicating when the first employee is unavailable to be recalled to work, wherein the first reserve schedule has a first reserve time period that coincides with the future time period;
identify a second employee associated with a second reserve schedule, the second reserve schedule comprising (1) one or more reserve time periods identified by the second employee, the one or more reserve time periods occurring during off-time that is outside one or more currently scheduled work shifts for the second employee and indicating when the second employee is potentially available to be recalled to work and (2) one or more unavailable time periods, the one or more unavailable time periods occurring during the off-time that is outside the one or more currently scheduled work shifts for the second employee and indicating when the second employee is unavailable to be recalled to work, wherein the second reserve schedule has a second reserve time period that coincides with the future time period;
transmit a first invitation to the first employee, the first invitation inquiring as to whether the first employee is willing to work during the first reserve time period identified in the first reserve schedule that coincides with the future time period to fulfill at least a portion of the second quantity of employee resources needed to work during the future time period;
receive a first reply from the first employee indicating whether the first employee is willing to work during the first reserve time period identified in the first reserve schedule that coincides with the future time period;
transmit a second invitation to the second employee, the second invitation inquiring as to whether the second employee is willing to work during the second reserve time period identified in the second reserve schedule that coincides with the future time period to fulfill at least a portion of the second quantity of employee resources needed to work during the future time period; and
receive a second reply from the second employee indicating whether the second employee is willing to work during the second reserve time period identified in the second reserve schedule that coincides with the future time period.

10. The non-transitory computer-readable storage medium of claim 9, wherein the first invitation is transmitted to the first employee and the second invitation is transmitted to the second employee in response to the first employee and the second employee meeting an employee qualification with respect to at least one of having seniority, having an acceptable pay rate, having a needed skill level, having a willingness to work during time outside scheduled work shifts, having a certain number of hours already scheduled to work, having a certain number of hours already worked over a particular time period, being a member of a team, and having a time period already scheduled to work proximate to the future time period.

11. The non-transitory computer-readable storage medium of claim 9, wherein the first invitation and the second invitation are transmitted at approximately a same time.

12. The non-transitory computer-readable storage medium of claim 9, wherein the second invitation is transmitted to the second employee after the first invitation has been transmitted to the first employee and the first reply has been received from the first employee.

13. The non-transitory computer-readable storage medium of claim 12, wherein the second invitation is transmitted to the second employee after the first invitation has been transmitted and the first reply has been received because the first employee has priority over the second employee.

14. The non-transitory computer-readable storage medium of claim 9, wherein the computer-executable instructions are further configured to cause the at least one computer processor to, in response to the first reply indicating the first employee is willing to work during the first reserve time period and the second reply indicating the second employee is willing to work during the second reserve time period, have the first employee scheduled to work during the first reserve time period as a result of the first employee having priority over the second employee.

15. The non-transitory computer-readable storage medium of claim 9, wherein the first invitation is transmitted to the first employee and the second invitation is transmitted to the second employee based on a probability of the first employee being willing to work during the first reserve time period and the second employee being willing to work during the second reserve time period.

16. The non-transitory computer-readable storage medium of claim 9, wherein the second invitation is transmitted to the second employee in response to the first reply indicating the first employee is not willing to work during the first reserve time period.

17. A system comprising at least one computer processor configured to:
determine an employee resource deficiency comprising a second quantity of employee resources needed to work during a future time period in addition to a first quantity of employee resources currently scheduled to work during the future time period;
identify a first employee associated with a first reserve schedule, the first reserve schedule comprising (1) one or more reserve time periods identified by the first employee, the one or more reserve time periods occurring during off-time that is outside one or more currently scheduled work shifts for the first employee and indicating when the first employee is potentially available to be recalled to work and (2) one or more unavailable time periods, the one or more unavailable time periods occurring during the off-time that is outside the one or more currently scheduled work shifts for the first employee and indicating when the first employee is unavailable to be recalled to work, wherein the first reserve schedule has a first reserve time period that coincides with the future time period;
identify a second employee associated with a second reserve schedule, the second reserve schedule comprising (1) one or more reserve time periods identified by the second employee, the one or more reserve time periods occurring during off-time that is outside one or more currently scheduled work shifts for the second employee and indicating when the second employee is potentially available to be recalled to work and (2) one or more unavailable time periods, the one or more unavailable time periods occurring during the off-time that is outside the one or more currently scheduled work shifts for the second employee and indicating when the second employee is unavailable to be recalled to work, wherein the second reserve schedule has a second reserve time period that coincides with the future time period;
transmit a first invitation to the first employee, the first invitation inquiring as to whether the first employee is willing to work during the first reserve time period identified in the first reserve schedule that coincides with the future time period to fulfill at least a portion of the second quantity of employee resources needed to work during the future time period;
receive a first reply from the first employee indicating whether the first employee is willing to work during the first reserve time period identified in the first reserve schedule that coincides with the future time period;
transmit a second invitation to the second employee, the second invitation inquiring as to whether the second employee is willing to work during the second reserve time period identified in the second reserve schedule that coincides with the future time period to fulfill at least a portion of the second quantity of employee resources needed to work during the future time period; and
receive a second reply from the second employee indicating whether the second employee is willing to work during the second reserve time period identified in the second reserve schedule that coincides with the future time period.

18. The system of claim 17, wherein the first invitation is transmitted to the first employee and the second invitation is transmitted to the second employee in response to the first employee and the second employee meeting an employee qualification with respect to at least one of having seniority, having an acceptable pay rate, having a needed skill level, having a willingness to work during time outside scheduled work shifts, having a certain number of hours already scheduled to work, having a certain number of hours already worked over a particular time period, being a member of a team, and having a time period already scheduled to work proximate to the future time period.

19. The system of claim 17, wherein the first invitation and the second invitation are transmitted at approximately a same time.

20. The system of claim 17, wherein the second invitation is transmitted to the second employee after the first invitation has been transmitted to the first employee and the first reply has been received from the first employee.

21. The system of claim 20, wherein the second invitation is transmitted to the second employee after the first invitation has been transmitted and the first reply has been received because the first employee has priority over the second employee.

22. The system of claim 17, wherein the at least one computer processor is configured to, in response to the first reply indicating the first employee is willing to work during the first reserve time period and the second reply indicating the second employee is willing to work during the second reserve time period, have the first employee scheduled to work during the first reserve time period as a result of the first employee having priority over the second employee.

23. The system of claim 17, wherein the first invitation is transmitted to the first employee and the second invitation is transmitted to the second employee based on a probability of the first employee being willing to work during the first reserve time period and the second employee being willing to work during the second reserve time period.

24. The system of claim 17, wherein the second invitation is transmitted to the second employee in response to the first reply indicating the first employee is not willing to work during the first reserve time period.

25. The method of claim 1, wherein each of the one or more reserve time periods identified in the first and second reserve schedules comprises at least a minimum time duration that is a whole number multiple of a minimum time interval used to construct one or more regularly scheduled work shifts for the first and second employees.

26. The non-transitory computer-readable storage medium of claim 9, wherein each of the one or more reserve time periods identified in the first and second reserve schedules comprises at least a minimum time duration that is a whole number multiple of a minimum time interval used to construct one or more regularly scheduled work shifts for the first and second employees.

27. The system of claim 17, wherein each of the one or more reserve time periods identified in the first and second reserve schedules comprises at least a minimum time duration that is a whole number multiple of a minimum time interval used to construct one or more regularly scheduled work shifts for the first and second employees.
